(19) United States
(12) Patent Application Publication
(10) Pub. No.: US 2013/0131883 A1
(43) Pub. Date: May 23, 2013

(54) ELECTRICITY MANAGEMENT SYSTEM FOR EFFICIENTLY OPERATING A PLURALITY OF ELECTRIC APPLIANCES, ELECTRIC APPLIANCE THEREFOR, CENTRAL CONTROL UNIT, COMPUTER PROGRAM AND STORAGE MEDIUM THEREOF, AND METHOD OF MANAGING ELECTRIC APPLIANCES BY THE CENTRAL CONTROL UNIT

(71) Applicant: Yusuke Yamada, Osaka-shi (JP)

(72) Inventor: Yusuke Yamada, Osaka-shi (JP)

(73) Assignee: SHARP KABUSHIKI KAISHA, Osaka-shi, Osaka (JP)

(21) Appl. No.: 13/805,203

(22) PCT Filed: Jun. 27, 2011
(86) PCT No.: PCT/JP2011/064665

§ 371 Date: Jan. 18, 2013

(30) Foreign Application Priority Data
Jun. 25, 2010 (JP) 2010-144351

(51) Int. Cl. G06F 1/26

(52) U.S. Cl. CPC G06F 1/26
USPC 700/295

(57) ABSTRACT

An electric appliance includes: a sensor; a control unit controlling status of power supply so that a numerical value obtained by the sensor is kept within a prescribed target range; a transmitting unit calculating, cycle periods of control in the steady status and power supply time period necessary to maintain the steady status and transmitting these to a central control unit; and a receiving unit receiving an instruction including cycle period information and time period information related to a power supply permitting time period in the cycle period specified by the cycle period information and applying the instruction to the control unit. The time periods of power supply to a plurality of electric appliances are adjusted not to overlap with each other, so that the peak power consumption of the system as a whole can be leveled.

### TECHNICAL FIELD

The present invention relates to a system for realizing cooperated operation of a plurality of electric appliances and, more specifically, to a system in which the electric appliances are connected as a network to a central control unit and the electric appliances are operated in a coordinated behavior by the function of the central control unit, as well as to a method of controlling the electric appliances.

### BACKGROUND ART

The present application claims priority on Patent Application No. 2010-144351 filed in Japan on Jun. 25, 2010, the entire contents of which are hereby incorporated by reference.

Recently, many households come to use electric appliances that require relatively high electric power, including an air conditioner, a refrigerator, a microwave oven, a washer-dryer, a dish washer-dryer and a hair dryer. When these electric appliances are used simultaneously, it becomes highly likely that the used electric power exceeds contracted amperage. Once the used power exceeds the contracted amperage, a circuit breaker trips. Once the breaker trips, all electric appliances in the household become unusable. Further, more significant problems may result. For example, assume that one is editing a file on a so-called desktop personal computer. If the breaker trips in this situation, the edited data would disappear. Such damage may not be recoverable.

In order to reduce such significant influence, a method of dividing the breaker into a plurality of sub-breakers has been adopted. With such a breaker arrangement, only a sub-breaker which is overloaded with excessive power use trips, and other sub-breakers are kept intact. Even with this approach, however, there may be an unexpected influence on electric appliances, though the scope of influence is limited. Therefore, measures to solve this problem have been desired.

One solution is a power control device having “a distribution panel with peak-cut-off function” described in Non-Patent Literature 1. The control device is provided combined with a residential power distribution panel. The control device has a built-in current sensor. If the current sensor detects overuse of electricity, the control device notifies by sound/voice. If electricity is overused to exceed the contracted amperage, electric appliances (up to four appliances can be designated) having a JEM-A terminal are automatically stopped. When power usage decreases thereafter, operation of these appliances is automatically resumed.

In some existing collective housings and single-family houses, due to low capacity mains, contracted amperage cannot be changed even though the quantity of power use has been increasing. The above-described control device is helpful for such houses.

Another solution to the problem described above is disclosed in Patent Literature 1. Patent Literature 1 discloses a technique of preventing tripping of the breaker by networking electric appliances and the breaker. Specifically, each electric appliance monitors whether or not there has been any trigger related to power consumption of a prescribed value or higher. By way of example, for an iron, power-on or increase of set temperature would be a trigger. For an air conditioner, power-on or increase of set temperature would be a trigger. For a microwave oven, power-on or start of inner microwave emission would be a trigger. When such a trigger is detected, the electric appliance determines a value of power consumption necessary for the process corresponding to the trigger by some means or other, and sends a message requiring use of that quantity of power to the breaker.

Receiving the message, the breaker extracts the required quantity of electric power usage included in the message. The breaker determines whether or not the sum of required quantity of electric power and the quantity of power that is being currently consumed is smaller than the maximum allowable power. If the determination is positive, the breaker returns a message allowing use of electric power to the electric appliance, and if not, it returns a message inhibiting use of electric power to the electric appliance.

The electric appliance starts consuming power if it receives the message allowing use from the breaker, and stops consuming power if it receives the message inhibiting the use.

By this scheme, when electric appliances consuming much power are to be used simultaneously in a household, it is possible to prevent the sum of power consumption from exceeding the maximum allowable power. Therefore, breaker tripping during use of electric appliances can be prevented.

It is noted that such a problem is not limited to a single household. Similar problem possibly occurs in a collective housing and the like involving multi-family units. To address such a problem, Patent Literature 2 discloses a technique of controlling power load of a collective housing as a whole to prevent overload on the mains to which power lines of households of the collective housing are connected.

Specifically, according to the technique described in Patent Literature 2, electric power supplied from an outdoor lamp line is divided to mains with a plurality of mains breakers, and further branched to branched lamp lines, through which the electric power is distributed to each household. A mains current control indicator acquires current values of current flowing through the mains breakers and stores the values in a memory, and predicts current value of mains of about 1 minute ahead. In accordance with the prediction, the mains current control indicator transmits a control instruction to electric appliances with power control function of each household. According to Patent Literature 2, the control instruction signal is carried by the lamp line.

The contents of Patent Literature 2 are classified to levels depending on the predicted value of mains current. The levels include “cancel energy saving mode,” “request cooperation for energy saving,” “execute air conditioner temperature control” and “turn off target appliance.” For example, if such control instructions are received, an air conditioner will execute a normal operation, execute an energy saving operation, change the set temperature and stop operation, respectively.

### CITATION LIST

### Non Patent Literature

NPL 1: “Power navigation unit with network control for residential distribution panel” [online] Tokyo Electric Power Company [Searched on Feb. 17, 2010], Internet (URL:http://tepco.co.jp/corporateinfo/provide/products/007-j.html)
NPL 2: “Smart tap functions and its applications” [online] Kyoto University, Matsuyama laboratory [Searched on Jun. 18, 2011] Internet, (URL: http://www.i-energy.jp/data/14-2010-9-24-symposium-demo.pdf)

### Patent Literature

PTL 1: Japanese Patent No. 3402953
PTL 2: Japanese Patent Laying-Open No. 2005-312210

### SUMMARY OF INVENTION

### Technical Problem

According to the technique described in Non-Patent Literature 1, when overuse of electric power is detected, use of a designated electric appliance is forced to stop. This technique is helpful to reliably prevent breaker tripping. Forced stop of using electric appliances, however, is not originally intended for the appliances, and convenience maintained by the use of electric appliances will be sacrificed.

The technique described in Patent Literature 1 is also helpful to reliably prevent breaker tripping. If use of electric power by electric appliances is prohibited as proposed by the technique of Patent Literature 1, however, the originally intended use of electric appliances cannot be realized. Therefore, as in the technique of Non-Patent Literature 1, convenience maintained by the use of electric appliances will be sacrificed.

The technique described in Patent Literature 2 is also helpful to reliably prevent tripping of mains breaker. If the set temperature of air conditioning is changed or the target appliance is turned off at an unintended timing, however, it is likely that essential functions of electric appliances are not fulfilled, and comfort and convenience would not fully be well-maintained.

If possible, it is desirable that electric appliances can be used continuously without sacrificing convenience, different from the techniques described in these references.

Therefore, the problem to be solved by the present invention is to provide a system for managing electric appliances capable of alleviating peak power load while ensuring fulfillment of native functions of the electric appliances, electric appliances used in the system, a computer program and a storage medium, a central control unit and a method of managing by the central control unit, a control device controlling power consumption by the electric appliances in accordance with instructions from the central control unit, and a control device for controlling power supply to the electric appliances.

Another object of the present invention is to provide a system for managing electric appliances capable of reducing possibility of exceeding contracted amperage while maintaining operations of electric appliances in originally intended use, electric appliances used in the system, a computer program and a storage medium, a central control unit and a method of managing by the central control unit, a control device controlling power consumption by the electric appliances in accordance with instructions from the central control unit, and a control device for controlling power supply to the electric appliances.

### Solution to Problem

According to a first aspect, the present invention provides an electric appliance, including: a controller controlling a controllable component consuming electric power to operate and controlling the electric power; a sensor obtaining information related to external environment prone to change reflecting a result of operation by the controllable component; a control device controlling the controller such that the electric power applied to the controllable component is adjusted to have a numerical value obtained by the sensor kept within a prescribed target range; and a timer synchronized with a prescribed reference time. The control device is capable of controlling the controller such that the controllable component attains to a steady status. The electric appliance further includes: a transmitting device for calculating, in response to the control by the control device entering the steady status, a cycle period in the steady status and a time period necessary for applying electric power to the controllable component to maintain the steady status and applying results of calculation to a prescribed central control unit through a communication interface; and a receiving device for receiving an instruction generated by the management apparatus, including cycle period information and time period information in which power supply to the controllable component is permitted within the cycle period specified by the cycle period information. The control device includes a device for controlling the controller such that electric power is supplied to the controllable component from a prescribed time point within the time period specified by the time period information and the numerical value obtained by the sensor is kept within the prescribed target range, based on the instruction received from the receiving device and on an output from the timer.

According to the present invention, the control device controls the controller such that the controllable component attains to a steady status. The operation of the controllable component is reflected on the information obtained by the sensor. The control device controls the controller such that the numerical value output from the sensor is kept within a target range. The cycle period at this time and a time period for applying electric power necessary to maintain the steady status to the controllable component are transmitted to the prescribed central control unit. In the prescribed central control unit, the time period in which electric power is applied to the electric appliance is determined in consideration of time periods of applying the electric power to other electric appliances, and an instruction can be transmitted accordingly to the electric appliance. When the receiving device receives the instruction, the control device controls the controller such that electric power is supplied to the controllable component in the time period designated by the instruction. The time period here is synchronized with a prescribed reference time, as in the case of other electric appliances. As a result, power consumption of not only this electric appliance but also of other electric appliances can be taken into consideration, and hence, problems possibly caused when electric appliances consume power individually and discretely can be avoided.

Preferably, the transmitting device includes: a status management device for managing status of control by the control device based on the output of the sensor; a cycle period measuring device for measuring, in response to the status managed by the status management device entering the steady status, cycle period of control by the control device in the steady status; a cycle period adjustment device for adjusting cycle period of control by the control device such that the cycle period measured by the cycle period measuring device comes closer to a target cycle period; and a device for calculating, in response to the status managed by the status management device entering the steady status and to a difference between the cycle period measured by the cycle period measuring device and the target cycle period becoming smaller than a prescribed threshold value, the target cycle period and a time period necessary for supplying electric power to the controllable component to maintain the steady status in the cycle period, and applying results of calculation to the central control unit through the communication interface.

More preferably, the control device controls electric power applied to the controllable component to any of a plurality of values so as to maintain the numerical value obtained by the sensor within the prescribed target range.

The plurality of values may include two values, that is, 0 and a prescribed positive value.

According to a second aspect, the present invention provides a central control unit for electric appliances, including: a receiving device receiving a notice related to a cycle period of power consumption and a time period requiring power supply, from each of a plurality of electric appliances of which power consumption changes periodically; a classifying device classifying, based on the notices received by the receiving device from the plurality of electric appliances, a group of electric appliances having the same cycle period; an allocating device allocating, for each of the group of electric appliances classified by the classifying device, a time period permitting power supply to each electric appliance in the cycle period, to have total power consumption by the electric appliances to which power supply is permitted in the cycle period made as flat as possible; and a notifying device for notifying each of the electric appliances included in each group of electric appliances classified by the classifying device, of the cycle period of power supply to the group and the time period in which power supply to the electronic appliance is allocated within the cycle period.

When the receiving device receives the notice, the classifying device classifies a group of electric appliances having the same cycle period. For each of the electric appliances belonging to the classified group, power supply permitting time period is positioned within the cycle period. Here, the total power consumption of electric appliances to which power supply is permitted is made as flat as possible within the cycle period. Therefore, the total power consumption can be reduced as compared with when the power supply permitting time periods of electric appliances overlap, and the power consumption can be leveled.

Preferably, the allocating device allocates a prescribed interval between the time period allocated to a first electric appliance and the time period allocated to a second electric appliance.

More preferably, the allocating device includes: a storage device for storing pieces of appliance information including power consumption of electric appliances of the group, identification numbers of the electric appliances, and time periods of power supply required by the electric appliances; a selecting device for selecting, from among the pieces of appliance information stored in the storage device, a piece corresponding to the appliance of which period of permitting power supply is not yet allocated in the cycle period; a power difference calculating device for calculating, for the piece of appliance information selected by the selecting device, after provisionally allocating power supply permitting time period permitting power supply to every possible positions in the cycle period, difference between maximum and minimum values of total power consumption of all electric appliances of which power supply permitting time periods are allocated in the cycle period at that time; a device for allocating the power supply permitting time period of the electric appliance selected by the selecting device at a position where the value calculated by the power difference calculating device is the smallest; and a device causing the selecting device, the power difference calculating device and the device for allocating to operate repeatedly from a status in which the power supply permitting time period is not yet allocated in the cycle period until a status in which the power supply permitting time periods of all electric appliances belonging to the group are allocated is attained.

According to a third aspect, the present invention provides a system for managing electric appliances, including: a network; one or more electric appliances connected to the network; and a central control unit connected to the network for managing the one or more electric appliances through the network such that the one or more electric appliances operate in a coordinated behavior. Each of the one or more electric appliances includes: a controllable component that operates receiving electric power; a sensor obtaining information related to external environment prone to change reflecting a result of operation by the controllable component; a control device controlling the electric power applied to the controllable component to maintain a numerical value obtained by the sensor within a prescribed target range; and a timer synchronized with a prescribed reference time. The control device is capable of controlling the controllable component such that it attains to a steady status. Each of the one or more electric appliances further includes: a transmitting device for calculating, in response to the control by the control device entering the steady status, a cycle period of control by the control device in the steady status and a time period necessary for applying electric power to the controllable component to maintain the steady status and applying results of calculation to a prescribed central control unit through a communication interface; and a receiving device for receiving an instruction generated by a transmission destination, including cycle period information and time period information in which power supply to the controllable component is permitted within the cycle period specified by the cycle period information. The control device includes a device for controlling the electric power supplied to the controllable component such that electric power is supplied to the controllable component from a prescribed time point within the time period specified by the time period information and the numerical value obtained by the sensor is kept within the prescribed target range, based on the instruction received from the receiving device and on an output from the timer. The central control unit includes: a receiving device receiving a notice related to a cycle period of power consumption and a time period requiring power supply, from the one or more electric appliances; a classifying device classifying, based on the notices received by the receiving device from the plurality of electric appliances, a group of electric appliances having the same cycle period; an allocating device allocating, for each of the group of electric appliances classified by the classifying device, a time period permitting power supply to each electric appliance in the cycle period, to have total power consumption by the electric appliances to which power supply is permitted in the cycle period made as flat as possible; and a notifying device for notifying each of the electric appliances included in each group of electric appliances classified by the classifying device, of the cycle period of power supply to the group and the time period permitting power supply to the electronic appliance within the cycle period.

According to a fourth aspect, the present invention provides a computer program, causing, when executed by a computer connected to one or more electric appliance, the computer to function as: a receiving device receiving a notice related to a cycle period of power consumption and a time period requiring power supply, from each of a plurality of electric appliances of which power consumption changes periodically; a classifying device classifying, based on the notices received by the receiving device from the plurality of electric appliances, a group of electric appliances having the same cycle period; an allocating device allocating, for each of the group of electric appliances classified by the classifying device, a time period permitting power supply to each electric appliance in the cycle period, to have total power consumption by the electric appliances to which power supply is permitted in the cycle period made as flat as possible; and a notifying device for notifying each of the electric appliances included in each group of electric appliances classified by the classifying device of the cycle period of power supply to the group and the time period in which power supply to the electronic appliance is allocated within the cycle period.

According to a fifth aspect, the present invention provides a storage medium storing the computer program described above.

According to a sixth aspect, the present invention provides a method of managing a central control unit for electric appliances, the central control unit including: a receiving device receiving a notice related to a cycle period of power consumption and a time period requiring power supply, from each of a plurality of electric appliances of which power consumption changes periodically; a classifying device classifying, based on the notices received by the receiving device from the plurality of electric appliances, a group of electric appliances having the same cycle period; an allocating device allocating, for each of the group of electric appliances classified by the classifying device, a time period permitting power supply to each electric appliance in the cycle period, to have total power consumption by the electric appliances to which power supply is permitted in the cycle period made as flat as possible; and a notifying device for notifying each of the electric appliances included in each group of electric appliances classified by the classifying device, of the cycle period of power supply to the group and the time period in which power supply to the electronic appliance is allocated within the cycle period. The method includes: the receiving step of the receiving device receiving a notice related to a cycle period of power consumption and a time period requiring power supply, from each of a plurality of electric appliances of which power consumption changes periodically; the classifying step of the classifying device classifying, based on the notices received at the receiving step from the plurality of electric appliances, a group of electric appliances having the same cycle period; the allocating step of the allocating device allocating, for each of the group of electric appliances classified at the classifying step, a time period permitting power supply to each electric appliance in the cycle period, to have total power consumption by the electric appliances to which power supply is permitted in the cycle period made as flat as possible; and the notifying step of the notifying device notifying each of the electric appliances included in each group of electric appliances classified at the classifying step of the cycle period of power supply to the group and the time period in which power supply to the electronic appliance is allocated within the cycle period.

According to a seventh aspect, the present invention provides a power control device for an electric appliance used connected to an electric appliance having a sensor for detecting information related to environmental condition prone to change reflecting a result of operation by itself and having a function of operating based on an output of the sensor to maintain the sensor output within a prescribed range, for controlling power consumption of the electric appliance. The power control device includes: a sensor output receiving device receiving a sensor output from the electric appliance; a timer synchronized with a prescribed reference time; a transmitting device detecting, based on an output from the sensor output receiving device, steady status of operation of the electric appliance being attained, calculating a cycle period in the steady status and a time period necessary for the electric appliance to receive power supply to maintain the steady status and transmitting calculated results to a prescribed central control unit; and a receiving device receiving an instruction from the central control unit. The instruction includes cycle period information for specifying a cycle period of operation of the electric appliance and on-permitting time period information permitting turning on of the controllable component in the cycle period specified by the cycle period information. The control device further includes: a power regulating device regulating power consumption of the electric appliance such that the electric appliance consumes power in the time period specified by the on-permitting time period information, based on the instruction received from the receiving device and on an output of the timer.

Preferably, the power control device further includes: a power sensor unit provided in relation to a power line supplying electric power to the electric appliance to enable detection of electric power supplied to the electric appliance through the power line; and a power consumption transmitting unit for periodically transmitting an output of the power sensor unit to the central control unit. The electric appliance may be capable of changing its status in response to an external instruction in accordance with a prescribed standard. The power regulating device includes an instruction transmitting unit transmitting an instruction to the electric appliance in accordance with the prescribed standard such that in synchronization with time keeping by the timer, for each cycle period, the electric appliance turns on at the head of the on-permitting time period and the electric appliance attains to an off status at the tail of the on-permitting time period.

The power regulating device may include a switch provided in a power supply line to the electric appliance, turning on at the head of the on-permitting time period and turning off at the tail of the on-permitting time period, in synchronization with time keeping by the timer, for each cycle period.

According to an eighth aspect, the present invention provides a power control device, used connected to an electric appliance having a function of detecting environmental condition prone to change reflecting a result of operation by itself and operating to have the environmental condition satisfy prescribed conditions, for controlling power consumption by the electric appliance. The power control device includes: a power sensor provided in relation to a power line supplying electric power to the electric appliance, enabling detection of electric power supplied through the power line to the electric appliance; a timer synchronized with a prescribed reference time; and a communication apparatus periodically transmitting an output of the power sensor to a prescribed central control unit and receiving an instruction from the central control unit. The instruction includes cycle period information specifying a cycle period of operation of the electric appliance and on-permitting time period information permitting turning on of the controllable component in the cycle period specified by the cycle period information. The power control device further includes a power supply switch for supplying electric power to the electric appliance in a time period specified by the on-permitting time period information and stopping power supply to the electric appliance in other time periods, for each cycle period, based on the instruction received from the central control unit and an output from the timer.

Preferably, the power control device further includes: a plug portion to be inserted to a receptacle for power supply; a receptacle portion for receiving a plug of the electric appliance; and a pair of lamp lines connecting the plug portion and the receptacle portion. The power supply switch includes: a relay inserted to either one of the pair of lamp lines; and a relay control device controlling the relay such that the relay is on in a time period specified by the on-permitting time period information and the relay is off in other time periods, for each cycle period, based on the instruction received from the central control unit and on an output from the timer.

### Advantageous Effects of Invention

According to the present invention, it becomes possible to have a plurality of electric appliances operate in mutually coordinated behavior and hence, power consumption of not only one electric appliance but also of other electric appliances can be taken into consideration, and hence, problems possibly caused when electric appliances consume power individually and discretely can be avoided.

### BRIEF DESCRIPTION OF DRAWINGS

FIG. 1 is a block diagram showing a schematic configuration of a home network system in accordance with the first embodiment of the present invention.

FIG. 2 is a graph showing an example of power consumption of an electric appliance.

FIG. 3 is a block diagram showing a functional configuration of an electric appliance (electric heater) as a component forming the home network system in accordance with the first embodiment.

FIG. 4 is a block diagram showing a functional configuration of the central control unit in accordance with the first embodiment.

FIG. 5 illustrates cycle period and its change depending on target temperature of the electric appliance (electric heater) in accordance with the first embodiment of the present invention.

FIG. 6 illustrates phase of the electric appliance (electric heater) in accordance with the first embodiment.

FIG. 7 illustrates duty ratio of a control signal for the electric appliance (electric heater) in accordance with the first embodiment.

FIG. 8 illustrates relation between power consumption of each appliance and total power consumption, when duty ratio of electric appliances is 0.58, with timings adjusted.

FIG. 9 is a graph showing change in power consumption of appliances (1) to (3) and total power consumption, when the duty ratio of electric appliances is 0.26.

FIG. 10 is a schematic graph illustrating a method of adjusting cycle period of an electric appliance, in accordance with the first embodiment.

FIG. 11 shows, in the form of a table, candidates of target cycle period.

FIG. 12 shows a protocol between the electric appliance (electric heater) and the central control unit, in accordance with the first embodiment.

FIG. 13 shows (A) contents of a notice from the electric appliance (electric heater) to the central control unit, and (B) contents of an instruction transmitted from the central control unit to the electric appliance (electric heater).

FIG. 14 illustrates a method of determining whether or not the current time is within the on-permitting time period, in accordance with the first embodiment.

FIG. 15 is a state transition diagram showing transition of internal status of the electric appliance (electric heater) in accordance with the prior art.

FIG. 16 is a state transition diagram showing transition of internal status of the electric appliance (electric heater) in accordance with the first embodiment.

FIG. 17 illustrates a method of determining whether or not timing to turn on has reached.

FIG. 18 illustrates a method of determining whether or not “on is to be continued against an instruction.”

FIG. 19 is a flowchart representing a control structure of a computer program executed when a switch is operated, in an electric appliance as a component forming the system in accordance with the first embodiment.

FIG. 20 is a flowchart representing a control structure of a computer program for heater control, executed periodically in the electric appliance forming the system in accordance with the first embodiment.

FIG. 21 is a flowchart representing a control structure of a computer program executed when STATE=1 in the electric appliance shown in FIG. 20.

FIG. 22 is a flowchart representing a control structure of a computer program executed when STATE=2 in the electric appliance shown in FIG. 20.

FIG. 23 is a flowchart representing a control structure of a computer program executed when STATE=3 in the electric appliance shown in FIG. 20.

FIG. 24 is a flowchart representing a control structure of a computer program executed when STATE=4 in the electric appliance shown in FIG. 20.

FIG. 25 is a flowchart representing a control structure of a computer program executed when STATE=5 in the electric appliance shown in FIG. 20.

FIG. 26 is a flowchart representing a control structure of a program executed by the central control unit when a notice from the electric appliance is detected.

FIG. 27 is a flowchart of the central control unit in accordance with the first embodiment.

FIG. 28 shows a table held in the central control unit in accordance with the first embodiment.

FIG. 29 shows an example of a method of allocation by the central control unit in accordance with the first embodiment.

FIG. 30 shows a result of computer simulation (operating three appliances having duty ratio of 0.32) in accordance with the first embodiment.

FIG. 31 shows a result of computer simulation (operating three appliances having duty ratio of 0.65) in accordance with the first embodiment.

FIG. 32 shows, in the form of a table, contents of a notice from the electric appliance (electric heater) to the central control unit, in accordance with a second embodiment.

FIG. 33 shows an example of allocation when power consumption differs among appliances.

FIG. 34 shows an example of a method of allocation by the central control unit in accordance with the second embodiment.

FIG. 35 shows an example of a method of allocation by the central control unit in accordance with the second embodiment.

FIG. 36 shows a graph showing transition of power consumption of a certain air conditioner.

FIG. 37 is a block diagram showing a configuration of a network system in a collective housing, in accordance with a fourth embodiment.

FIG. 38 is a flowchart of a program for the central control unit to calculate operation cycle period of an electric appliance.

FIG. 39 is a block diagram showing a schematic configuration of a home network system in accordance with a fifth embodiment.

FIG. 40 shows an appearance of a power consumption measuring device with appliance control function, used in the fifth embodiment.

FIG. 41 shows an appearance of a back side of the power consumption measuring device shown in FIG. 40.

FIG. 42 is a block diagram of the power consumption measuring device shown in FIGS. 40 and 41.

FIG. 43 is a block diagram showing another example of the power consumption measuring device with appliance control function.

FIG. 44 is a block diagram of a power consumption measuring device with power switching function, used in a sixth embodiment.

FIG. 45 is a flowchart of a program executed if an instruction including a cycle period and an on-permitting time period is received from the central control unit, in the power consumption measuring device shown in FIG. 44.

FIG. 46 is a block diagram of a power consumption measuring device with a remote controller function, used in a seventh embodiment.

### DESCRIPTION OF EMBODIMENTS

In the following, the system in accordance with embodiments of the present invention will be described. In the following description, the same components are denoted by the same reference characters. Their functions are also the same. Therefore, detailed description thereof will not be repeated.

[Basic Concept]

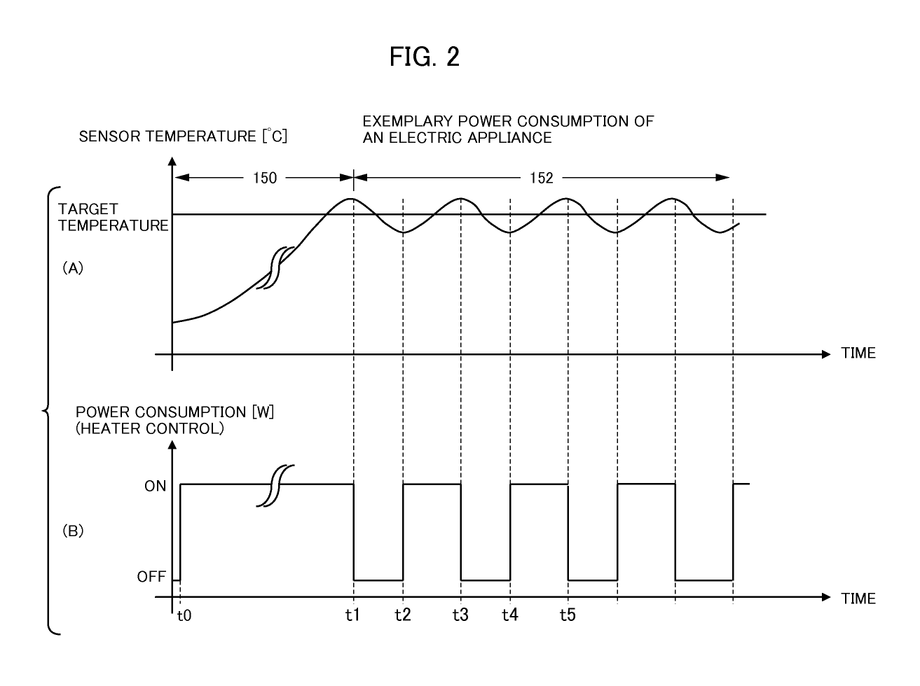

FIG. 2 shows an example of power consumption by a certain electric appliance. Here, as an example of the electric appliance, consider temperature control of a heater. For convenience of description, it is assumed that the heater is controlled by two values corresponding to on/off.

As can be seen from FIG. 2, when a target temperature is given, the electric appliance operates in the following manner. The temperature is monitored by a temperature sensor. In the following, the monitored temperature will be referred to as “sensor temperature.” If the sensor temperature is lower than the target temperature, power supply to the heater is turned on. When power supply to the heater is turned on, the sensor temperature increases. If the sensor temperature reaches the target temperature, power supply to the heater is turned off. When the power supply to the heater is turned off, the sensor temperature decreases. If the sensor temperature reaches the lower limit of target temperature, power supply to the heater is again turned on. Thereafter, on/off of the power supply to the heater is repeated so that the sensor temperature is kept within a prescribed range with the target temperature being the center (hereinafter, the range will be referred to as the “target temperature range”). In the following, this status of repetition will be referred to as a steady status 152. A status after switch-on until the steady status is attained will be referred to as a transitional status 150.

Once the steady status 152 is attained, it would not pose any problem if the timing of turning on/off of the power supply to the heater is shifted forward or backward to some extent, as long as the sensor temperature is kept in the target temperature range. In other words, such a manner of power supply is within the scope of originally intended use.

Assume, for example, that a plurality of electric appliances as described above are provided. If each electric appliance operates individually, peak power of the appliances combined cannot be reduced. If the electric appliances are operated in a coordinated behavior with on/off timings adjusted in accordance with an idea, the peak power can be reduced. For instance, if three of the electric appliances are operated, it is possible to prevent that power is simultaneously supplied, or turned on, to all three heaters.

Since various and many electric appliances are used at home, it may be possible that a condition causing breaker tripping may be met immediately after an electric appliance, different from these coordinated electric appliances, is turned on. If the power use among the electric appliances that can be operated in the coordinated behavior is made as level as possible, the possibility of breaker tripping immediately after turning on a different electric appliance could be reduced.

In the embodiments below, a heater will be described as the electric appliance of relatively high power consumption. It is apparent that application of the present invention is not limited to the heaters. Any appliance that consumes electric power can be the controllable component of the present invention.

### First Embodiment

In the first embodiment, it is assumed that the electric appliance is a heater, which requires temperature control (on/off control). Further, for easier understanding, description will be given assuming that a plurality of similar electric appliances are provided and each electric appliance consumes the same quantity of electric power.

<Home Network System>

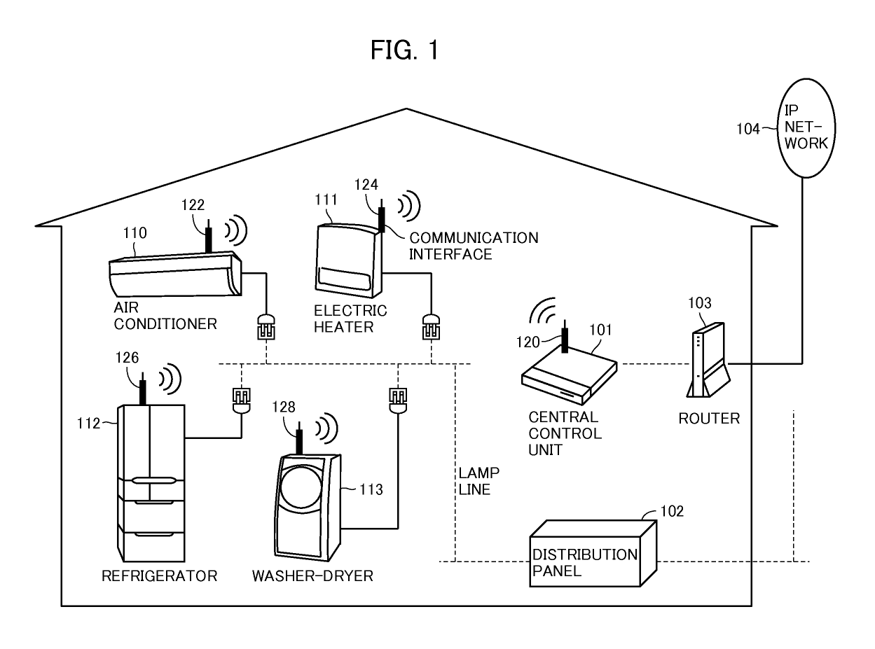

Referring to FIG. 1, a home network system in accordance with the first embodiment of the present invention includes a distribution panel 102, a router 103, an air conditioner 110, an electric heater 111, a refrigerator 112 and a washer-dryer 113, as well as a central control unit 101 regulating these electric appliances to operate in a coordinated behavior. Air conditioner 110, electric heater 111, refrigerator 112 and washer-dryer 113 are examples of typical electric appliances used at home, and not limiting. Electric heater 111, refrigerator 112 and washer-dryer 113 all have electric power supplied from lamp line of distribution panel 102.

Air conditioner 110, electric heater 111, refrigerator 112, washer-dryer 113 and central control unit 101 have communication interfaces (hereinafter, “interface” will be simply denoted as “I/F”) 122, 124, 126, 128 and 120, respectively. Air conditioner 110, electric heater 111, refrigerator 112 and washer-dryer 113 can each communicate with central control unit 101 through these communication I/Fs. It goes without saying that both transmission and reception is possible in the communication through communication I/Fs. In each program of embodiments described below, “notify” or “notice” means a transmission operation through the communication I/F when viewed from a transmitting side appliance/apparatus, and it is a reception operation when viewed from a receiving side appliance/apparatus.

Possible examples of communication OF are as follows. For wireless communication, ZigBee (IEEE 802.15.4), Bluetooth (registered trademark), specified low power wireless communication, infrared communication, and wireless LAN (IEEE802.11) are available. For wired communication, PLC (Power Line Communication), RS-485 and Ethernet (registered trademark) are available. Regarding PLC, communication at high speed (up to about 200 Mbps) and low speed (several tens of kbps) are available. For the purpose of the present invention, low speed is sufficient. For instance, a standard referred to as HomePlug Command and Control (HomePlug C & C) is used. Since PLC does not necessitate installation of new wiring, it is convenient for the purpose of the present invention. The communication I/F may be a hybrid communication path combining wired and wireless methods.

The communication I/F is not limited to the above, and any interface may be used as long as it enables communication between central control unit 101 and electric appliances used in the household. The function enabling direct communication between each of air conditioner 110, electric heater 111, refrigerator 112 and washer-dryer 113 is unnecessary.

It is assumed that central control unit 101 is capable of communication with air conditioner 110, electric heater 111, refrigerator 112 and washer-dryer 113 through communication I/F 120. Central control unit 101 serves as a central apparatus (coordinator) of communication I/F 120. Further, central control unit 101 may have a function of obtaining statuses of air conditioner 110, electric heater 111, refrigerator 112 and washer-dryer 113 and realizing simple control thereof.

Central control unit 101 may be connectable to an IP network 104 through a router 103 connected by high-speed communication I/F. If it is connected to IP network 104, statuses of air conditioner 110, electric heater 111, refrigerator 112 and washer-dryer 113 can be obtained from a distant location and to execute simple control thereof.

<Electric Heater 111>

In the following description, a configuration of electric heater 111 will be described, as a representative example of the electric appliance controlled by central control unit 101.

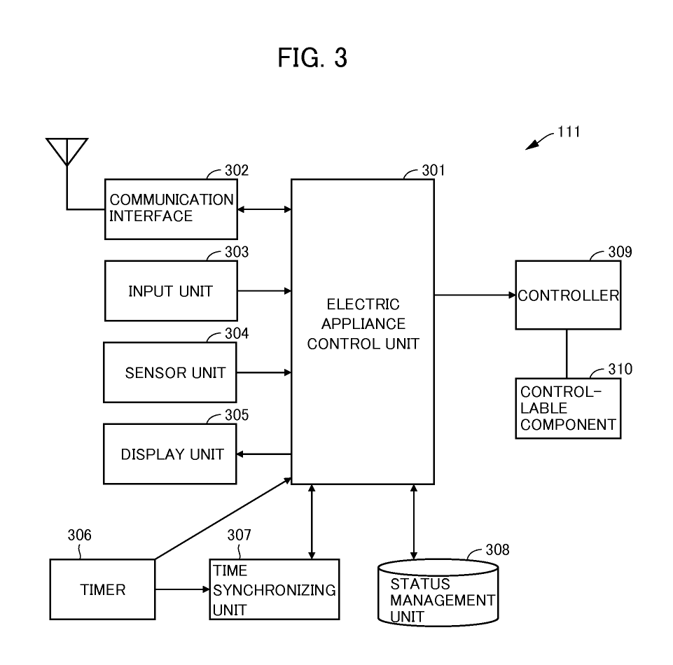

Referring to FIG. 3, electric heater 111 includes an electric appliance control unit 301, a communication I/F 302, an input unit 303, a sensor unit 304 for measuring temperature, a display unit 305, and a timer 306. Electric heater 111 further includes a status management unit 308 for managing state transition, a time synchronizing unit 307 connected to timer 306, and a controller 309 controlling a controllable component 310.

Electric appliance control unit 301 is, specifically, a one-chip microcomputer (embedded CPU (Central Processing Unit)) containing an ROM (Read Only Memory) and an RAM (Random Access Memory), and it has a function of realizing overall control of the electric appliance based on a program.

Communication I/F 302 is, specifically, a communication module such as ZigBee. Electric appliance control unit 301 communicates with central control unit 101 through communication I/F 302.

Input unit 303 is, specifically, an input device such as a power switch or a button. Input unit 303 is used for turning the power of electric heater 111 on/off, or to input a target temperature.

Sensor unit 304 is, specifically, a temperature sensor or the like. Sensor unit 304 measures current temperature and applies the result of temperature measurement to electric appliance control unit 301. The result of temperature measurement reflects the result of operation of the heater, and it is used for controlling the heater, by electric appliance control unit 301.

Display unit 305 is, specifically, a liquid crystal or LED display device. Display unit 305 is used for displaying the status of power supply, target temperature and current temperature of electric heater 111.

Timer 306 is, specifically, a crystal oscillator or the like. Timer 306 is used for establishing time synchronization and for controlling electric appliance control unit 301.

Time synchronizing unit 307 is, specifically, a program that operates in the one-chip microcomputer. With respect to central control unit 101, time synchronizing unit 307 has a function of a client, synchronized in time with the timer. The start time and end time of an on-permitting time period as will be described later are determined by time measurement by the timer, with the head of each cycle period being 0.

Electric appliance control unit 301 transmits/receives packets to/from central control unit 101 through communication I/F 302, and realizes time setting. Specifically, electric appliance control unit 301 and central control unit 101 have common time. The process for time setting may be realized using conventional technique such as NTP (Network Time Protocol).

Status management unit 308 is, specifically, a storage device contained in the one-chip microcomputer. Status management unit 308 stores the status of electric heater 111. Electric appliance control unit 301 stores the internal status of electric heater 111 in status management unit 308. The information stored in status management unit 308 as the internal status of electric heater 111 contains contents of an instruction issued by electric appliance control unit 301 to controller 309 and history information of its timing. With the history information, it is possible for electric appliance control unit 301 to determine whether electric heater 111 is in the transitional status or in the steady status.

Electric appliance control unit 301 transmits the internal status of electric appliance to central control unit 101. Specifically, electric appliance control unit 301 also functions as a transmitting device transmitting the internal status to central control unit 101. Further, electric appliance control unit 301 receives an operation timing instruction from central control unit 101, and stores it in status management unit 308. Specifically, electric appliance control unit 301 also functions as a receiving device. The operation timing instruction is an instruction designating timing when the heater is electrically conducted, in electric heater 111. The operation timing instruction includes a cycle period, and a start time and an end time of the time period in which on operation is permitted.

Controller 309 is, specifically, a relay. Controller 309 has a function of controlling power supply to the controllable component 310 in accordance with an output from electric appliance control unit 301.

Electric appliance control unit 301 provides an output to controller 309 based on the target temperature input by input unit 303, the current temperature obtained by sensor unit 304, and the operation timing instruction stored in status management unit 308.

The controllable component 310 is, specifically, the heater or a metal resistance heating element, in the case of electric heater 111. The controllable component 310 receives power supply and generates heat.

As can be understood from the foregoing description, electric heater 111 controlled by central control unit 101 of the present embodiment has a configuration similar to a common electric heater, except for communication I/F 302, time synchronizing unit 307 and status management unit 308.

<Central Control Unit 101>

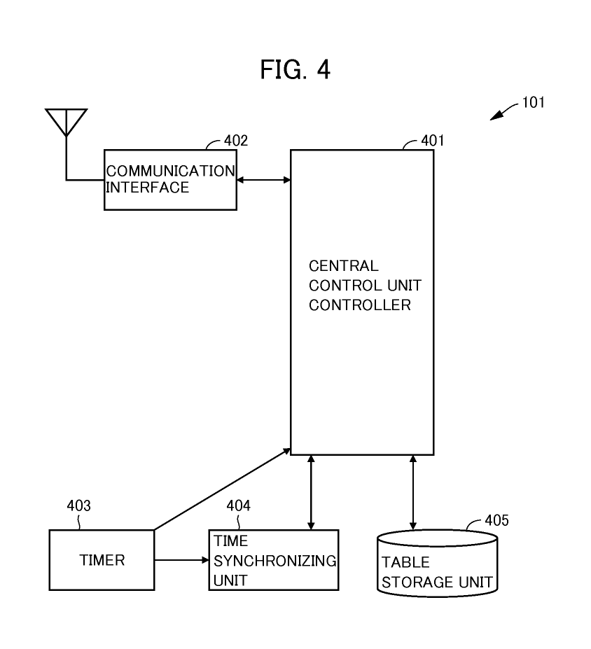

Referring to FIG. 4, central control unit 101 in accordance with the present embodiment includes a central control unit controller 401, a communication I/F 402, a timer 403, a time synchronizing unit 404 and a table storage unit 405.

Central control unit controller 401 is, specifically, a CPU module containing an ROM and an RAM. Central control unit controller 401 realizes overall control of central control unit 101 based on a program.

Communication I/F 402 is, specifically, a communication module such as ZigBee. Central control unit controller 401 communicates with electric appliances such as electric heater 111 through communication I/F 402. Specifically, central control unit controller 401 has a function of transmitter/receiver.

Timer 403 is, specifically, a crystal oscillator. Timer 403 is used for establishing time synchronization and for controlling central control unit controller 401.

Time synchronizing unit 404 is, specifically, a program operated by the CPU. Time synchronizing unit 404 has a time-synchronized server function. Specifically, time synchronizing unit 404 has a function of notifying the time held by central control unit 101 to each of the electric appliances managed by central control unit 101. Time synchronizing unit 404 may simultaneously have a function of time-synchronized client function. Specifically, time synchronizing unit 404 may be connected to an external time server (NTP server) through an IP network 104 (not shown in FIG. 4) and may establish time synchronization with the time sever. As a result, all electric appliances and central control unit 101 connected to the network come to operate in synchronization with a prescribed reference time.

Table storage unit 405 is, specifically, a storage device contained in the CPU module. Table storage unit 405 stores information received from the electric appliances such as electric heater 111 and information to be transmitted to the electric appliances.

Though not shown in FIG. 4, central control unit 101 in accordance with the present embodiment may additionally include a high-speed communication I/F such as Ethernet (registered trademark), a touch-panel controller, or a liquid crystal controller. If high-speed communication I/F is provided, central control unit 101 can be connected to IP network 104 through router 103 at home.

In the present embodiment, it is assumed that central control unit 101 exists by itself. The present invention, however, is not limited to such a form. Specifically, any of the electric appliances may have the role of central control unit 101. It is possible that an electric appliance has a function of a central control unit. It is noted, however, that only one appliance functions as the central control unit, in the home communication network.

A general personal computer may be used as central control unit 101. Alternatively, if there is an HEMS (Home Energy Management System) controller in the household, the HEMS controller may be adapted to function as central control unit 101.

<Method of Controlling Electric Heater>

The basic method of controlling an electric heater is as shown in FIG. 2. In this method of control, the timing of turning on/off the power supply to the heater may be understood in terms of cycle period and phase of the heater power conduction. Specifically, a time period as a sum of an on-period and an off-period next to the on-period of power supply to the heater is regarded as a cycle period of power supply to the heater of electric heater 111. As to the phase, various time points may be used as a reference. By way of example, the instant when power supply to the heater started (start time of heater power supply) may be considered to correspond to phase 0. That the timing of turning on/off the heater is changed means changing the cycle period and the phase of the power supply to the heater.

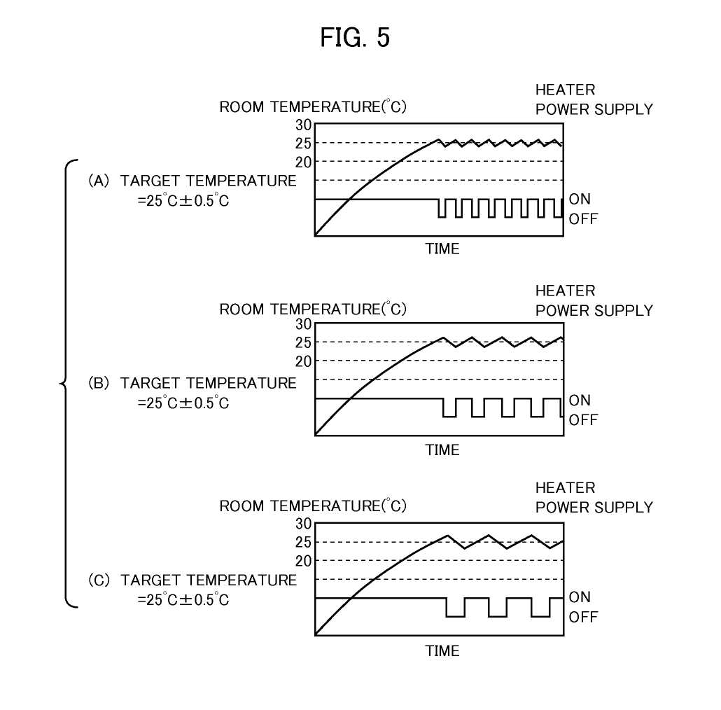

Referring to FIG. 5, the relation between the cycle period and the phase of electric heater will be described. FIG. 5(A) shows a result of simulation related to the time of power supply to the heater and the room temperature, when target temperature is set to 25°±0.5°. FIG. 5(B) shows a result of similar simulation when target temperature is set to 25°±1.0°. FIG. 5(C) shows a result of similar simulation when target temperature is set to 25°±1.5°.

Referring to (A), (B) and (C) of FIG. 5, in any of the examples, the room temperature is low immediately after the switch is turned on. If power supply to the heater is continued for some time, the room temperature becomes closer to the target temperature. Then, power supply to the heater comes to be turned on/off repeatedly, with a prescribed cycle period. This corresponds to the steady status. In contrast, the status from the time point of initial switch-on until the steady status is attained is transitional. This status is referred to as the transitional status. From (A) to (C) of FIG. 5, it can be seen that the cycle period of on and off of the power supply to the heater after the steady status is attained changes by adjusting the range of target temperature. If the cycle period is to be made longer, the range of target temperature should be set wider. If the cycle period is to be made shorter, the range of target temperature should be made narrower. Generally speaking, the cycle period can be changed by adjusting the range of target temperature. How much the cycle period can be changed, however, differs depending on hardware characteristics and on the user's request. Therefore, the possible range of cycle period depends on actual implementation.

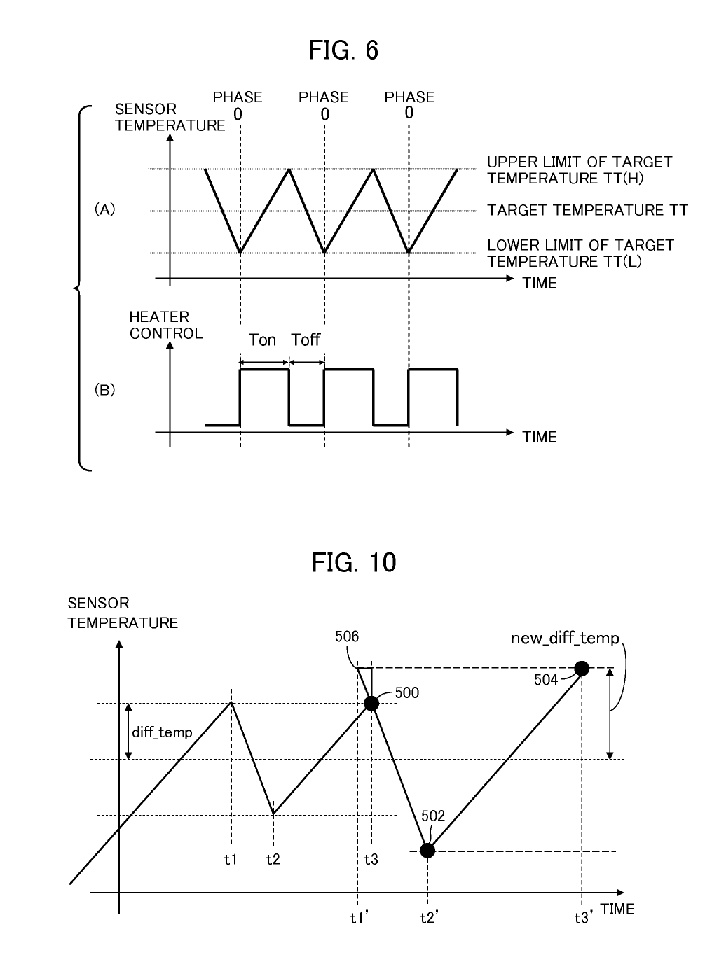

Referring to FIG. 6, the phase of electric appliance (electric heater) will be described. As described above, it is possible to consider that the instant when power supply to the heater starts or turned on corresponds to phase 0. As can be readily understood from FIG. 6, as long as the room temperature is within the range of target temperature, it is possible to set ahead the timing of turning on/off power supply to the heater.

Referring to (B) of FIG. 6, the time period in which the power supply to the heater is on will be denoted as Ton, and the time period in which the power supply to the heater is off will be denoted as Toff. The duty ratio of a signal controlling power supply to the heater represents the ratio of on-period in one cycle period and, therefore, it can be represented as Ton/(Ton+Toff). As shown in (B) of FIG. 6, the duty ratio calculated when the on-period and off-period of a certain electric appliance are represented by a waveform will be referred to as the duty ratio of the electric appliance in the present embodiment.

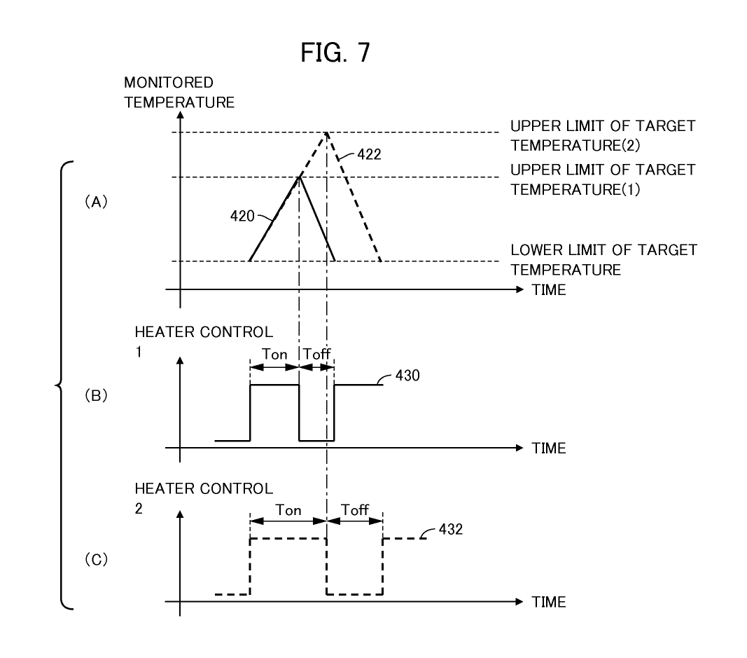

Referring to FIG. 7, the duty ratio of electric appliance when the range of target temperature is changed will be considered. Examples of time change of the sensor temperature when two different upper limits were set for the target temperature are shown in (A) of FIG. 7. The solid line represents the first upper limit of target temperature, and the dotted line represents the second upper limit of target temperature (where first upper limit of target temperature<second upper limit of target temperature). As can be seen from (A) of FIG. 7, sensor temperature 420 when the upper limit of target temperature is low (the range of target temperature is narrow) reaches the upper limit faster than sensor temperature 422 when the upper limit of target temperature is high (the range of target temperature is wide). Therefore, the power supply to heater is turned off earlier and the sensor temperature starts to decrease.

In FIG. 7, (B) and (C) represent heater controls 430 and 432 when the first and second upper limits of target temperature were set. As can be seen from these, generally, power supply to the heater is kept on until the sensor temperature reaches the upper limit of target temperature and once the upper limit of target temperature is reached, power supply to the heater is turned off.

Assuming that the rate of temperature increase (slope) is substantially the same as the rate of temperature decrease (slope), the two peaks come to have similar triangles as can be seen from (A) of FIG. 7. Namely, even if the range of target temperature is changed slightly, the duty ratio is substantially unchanged.

Now, let us consider how the peak power can be reduced by adjusting the timing of turning on/off the plurality of electric appliances. How much the peak power can be reduced depends on the duty ratio of each of the electric appliances.

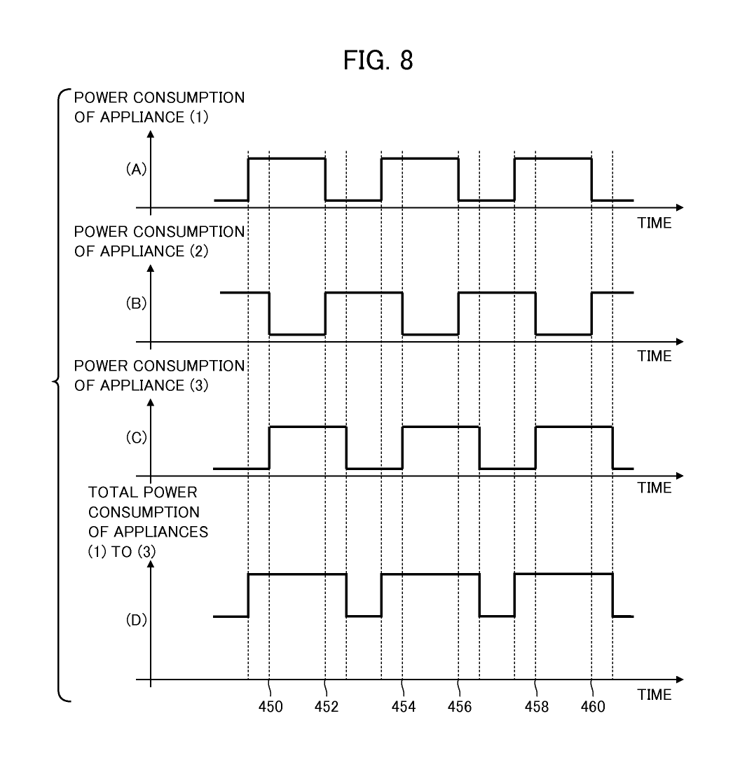

FIG. 8 shows an example in which three electric appliances, each having the duty ratio of 0.58, are provided. In FIG. 8, (A), (B) and (C) show examples of power on/off timing of appliances (1), (2) and (3), respectively. Here, the on/off timing is adjusted such that immediately after appliance (1) is turned off (time points 452, 456, 460 etc.), appliance (2) is turned on, and immediately after appliance (2) is turned off (time points 450, 454, 458 etc.), appliance (3) is turned on. Then, the total power consumption of appliances (1) to (3) comes to be as shown in (D) of FIG. 8. As is apparent from (D) of FIG. 8, here, at least one appliance is on at any time point. There is also a time period in which two appliances are simultaneously on. It is noted, however, that the three appliances are not all on simultaneously.

In the example shown in FIG. 8, the sum of duty ratios of appliances (1) to (3) is 0.58+0.58+0.58=1.74. Generally, if the sum of duty ratios of controlled electric appliances exceeds 1, there arises a time period in which two appliances are simultaneously on. If the sum of duty ratios is equal to or smaller than 2, a time period in which three appliances are all simultaneously on can be avoided.

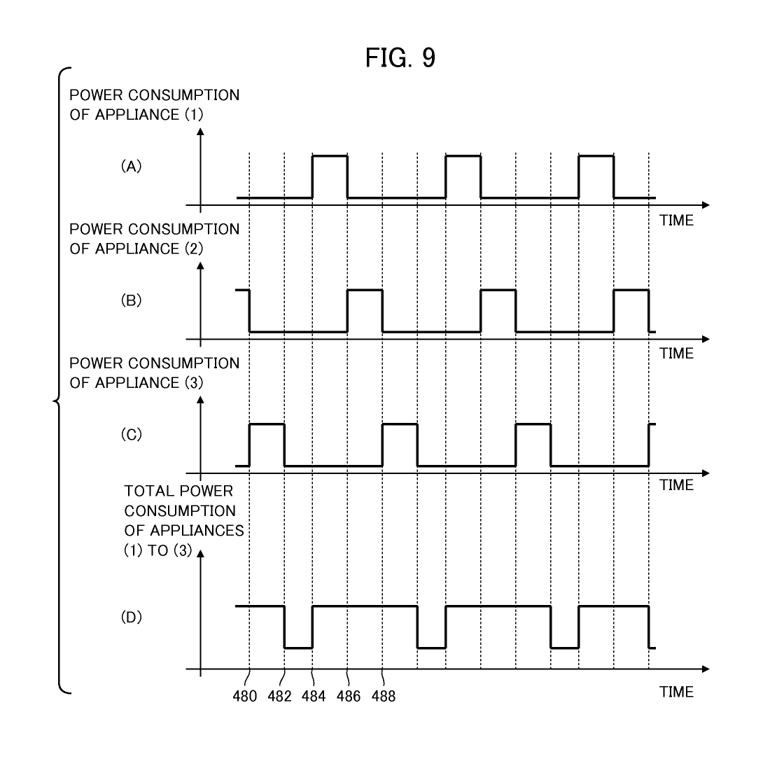

FIG. 9 shows an example in which three electric appliances each having the duty ratio of 0.26 are provided. In FIG. 9, (A), (B) and (C) show examples of power on/off timing of appliances (1), (2) and (3), respectively. Here, the on/off timing is adjusted such that immediately after appliance (1) is turned off (time point 486 etc.), appliance (2) is turned on, and immediately after appliance (2) is turned off (time points 480, 488 etc.), appliance (3) is turned on. Then, the total power consumption of appliances (1) to (3) comes to be as shown in (D) of FIG. 9. As can be seen from (D) of FIG. 9, here, there is no time period in which two appliances are simultaneously turned on. There is also a time period such as from time point 482 to 484 that none of the electric appliances is on.

In this example, the sum of duty ratios is 0.26+0.26+0.26=0.78. Generally, if the sum of duty ratios is equal to or smaller than 1, a time period in which two appliances are simultaneously on can be avoided.

The consideration above will be generalized. Assume that there are N appliances, each having the duty ratio of dᵢ (i=0 . . . N−1).

If there is a positive integer M that satisfies the relation

$$M - 1 < {\sum }_{i = 0}^{N - 1} {d}_{i} < M , \qquad ( 1 )$$

then, it follows that there is a time period in which M appliances are simultaneously on, while a time period in which M+1 appliances are simultaneously on can be avoided.

As to the timing of operating respective appliances, an order may be decided among the appliances, and the timing may be adjusted such that immediately after the appliance (k) is turned off, the appliance (k+1) is turned on (where k=1 . . . N).

Next, power consumption will be considered. The power consumption when the power supply to the electronic appliance (electric heater) is off will be denoted as Poff, and power consumption when the power supply to the heater is on will be denoted as Pon. When there are N such electric appliances among which M appliances are on and N-M appliances are off in the steady status, the total power consumption can be represented by Equation (2) below.

M*Pon+(N−M)*Poff (2)

A specific example will be described. Assume that five appliances, each having the duty ratio of 0.58, power consumption when the motor control is off is 2 W and power consumption when power supply to the heater is on is 800 W are operated. Here, the total sum of duty ratios is 0.58*5=2.9≦3. Therefore, the number of appliances or heaters to which power is simultaneously supplied or which are turned on can be limited to at most 3. Specifically, the power consumption can be reduced to 3*800 W+(5−3)*2 W=2040 W.

In contrast, if these appliances are operated independently, it is possible that all five appliances are on simultaneously. Then, the peak power consumption can be as high as 5*800=4000 W.

The consideration above is based on the premise that the cycle periods of electric appliances are the same. The reason for this is that it is impossible to combine electric appliances having different cycle periods to operate in a coordinated behavior. Therefore, it is assumed that the electric appliances controlled in the present embodiment have the function of adjusting the cycle period in the steady status.

FIG. 10 shows the method of adjusting cycle period of the electric appliance. The cycle period can be adjusted by making narrower or wider the range of target temperature, as described above. Referring to FIG. 10, the timing of turning off→on→off the power supply to the heater will be denoted as t1→t2→t3. The target temperature is represented as target_temp, and the acceptable error of target temperature is represented as diff_temp (>0). Then, the range of target temperature is represented by Equation (3) below.

target_temp±diff_temp (3)

Referring to FIG. 10, at time point t3 (point 500 of the sensor temperature graph), the cycle period up to that time point (=t3−t1) can be known. Therefore, when the target cycle period (Tp) is given, whether the cycle period is to be adjusted at this timing is determined. As a specific example, if the cycle period is shifted by 3% or more than the target cycle period, it is determined that the cycle period is to be adjusted. Here, the cycle period is adjusted by changing the range diff_temp of target temperature to a new range new_diff_temp (>0).

new_diff_temp=diff_temp/(t3−t1)*Tp (4)

As can be seen from Equation (4), when the cycle period is to be made longer, the new acceptable error (new_diff_temp) is made larger than the previous allowable error (diff_temp). If the cycle period is to be made shorter, the new acceptable error (new_diff_temp) is made smaller than the previous allowable error (diff_temp).

At time point t3 shown in FIG. 10, control is done in the same manner as has been done, with the allowable error changed. By this operation, the cycle period is changed. The subsequent timing of turning off→on→off the power supply to the heater will be denoted as t1′→t2′→t3′. Here, time points t2′ and t3′ represent time points when the sensor temperature reached the lower limit and the upper limit (represented by points 502 and 504 in the graph of sensor temperature) of acceptable range, respectively. In contrast, time point t1′ is calculated from time point t3 in accordance with Equation (5) or (6) below. In FIG. 10, this time point corresponds to a point 506 where an extension of a line connecting point 502 and point 500 intersects the new upper limit temperature. The time point t1′ should not be the same as t3.
(a) WHEN new_diff_temp>diff_temp,

t1′=t3−(t2−t1)/2*(new_diff_temp/diff_temp−1) (5)
(b) WHEN new_diff_temp<diff_temp,

t1′=t3+(t2−t1)/2*(1−new_cliff_temp/diff_temp) (6)

Calculation of time point t1′ in this manner is necessary to accurately measure the new cycle period based on the new acceptable error.

Referring to FIG. 10, at time point t3′, again, the cycle period (=t3′−t1′) is compared with the target cycle period. The above-described process is repeated until it is determined that the cycle period is sufficiently close to the target cycle period.

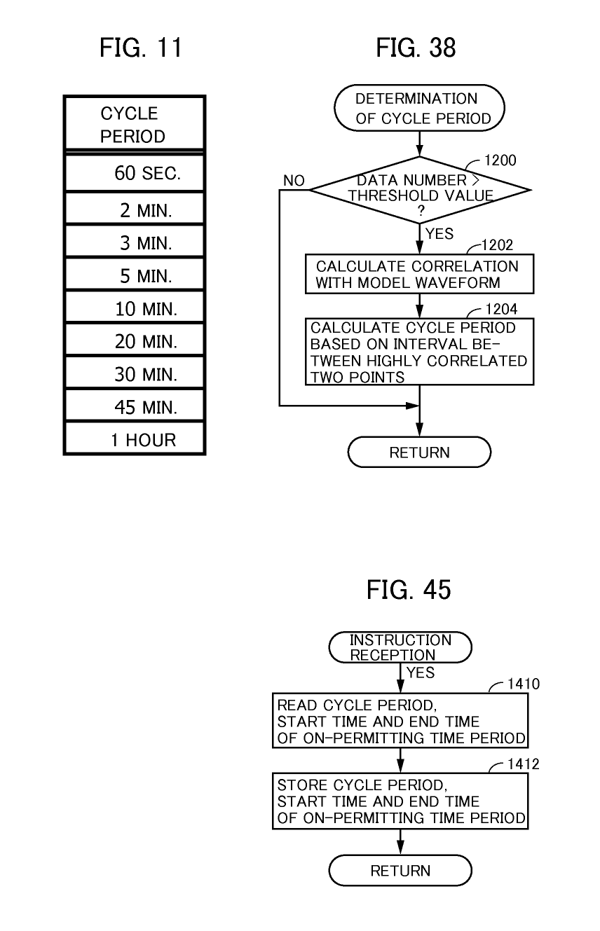

To what value the target cycle period is to be set may differ depending on the electric appliances. It may be helpful, however, to allow selection from among a number of candidates. FIG. 11 shows candidates of target cycle periods. Each electric appliance selects an optimal target cycle period from the candidates such as shown in FIG. 11. Specifically, the value close to the cycle period when each electric appliance operate in the ordinary manner is selected as the target cycle period. Depending on the electronic appliance, the target cycle period may be defined in advance.

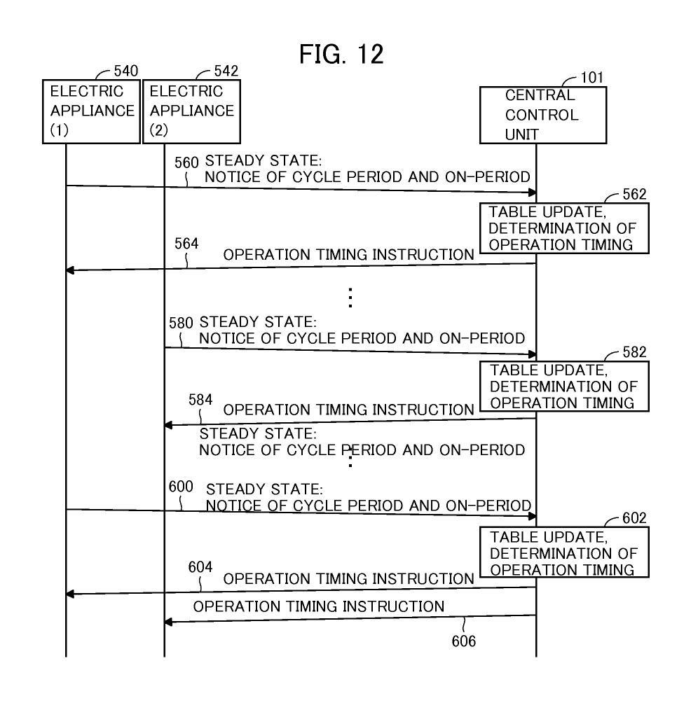

FIG. 12 shows a protocol of communication between the electronic appliance and central control unit 101. Here, consider electric appliances 540 and 542 as electronic appliances to be controlled by central control unit 101.

In the present embodiment, if the cycle period in the steady status comes sufficiently close to the target cycle period, electric appliances 540 and 542 notify central control unit 101 of the cycle period and the on-period necessary to maintain the steady status (notice 560, 580 an 600).

Receiving the notice from electric appliances 540 and 542, central control unit 101 updates the table (boxes 562, 582 and 602). In the table, identification number of each electric appliance, the cycle period and the necessary on-period are stored.

Central control unit 101 determines, for the electric appliances having matching cycle periods, the timing of operation of these electric appliances. Here, it is assumed that electric appliances 540 and 542 have matching cycle periods. Central control unit 101 transmits an operation timing instruction to each of the electric appliances 540 and 542 (notices 564, 584, 604 and 606). The operation timing instruction includes the cycle period, and the start time and end time of a time period in which on-operation is permitted. The table further includes instructions of operation timing that have been transmitted in the past by central control unit 101. If the instruction of operation timing is the same as one transmitted in the past, it is unnecessary to send the instruction again to the same electric appliance.

When the instruction of operation timing is received, electric appliances 540 and 542 determine their operations with reference to the instruction. It is desirable that each electric appliance turns on in the on-operation permitting time period and turns off outside the on-operation permitting time period. The appliance does not always follow the instruction if, for example, maintenance of sensor temperature within the target temperature range is given priority. The on-operation permitting time period refers to a time period in which power supply to the heater is permitted.

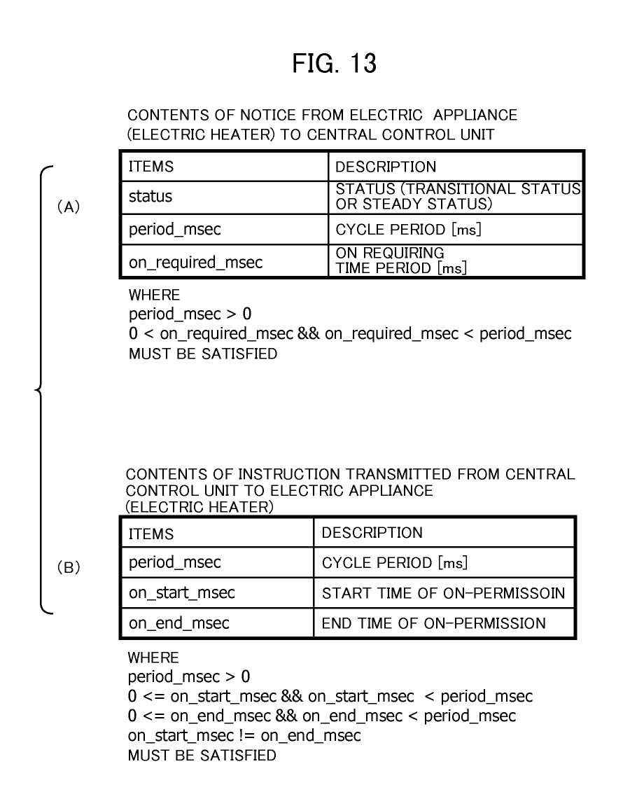

Referring to (A) of FIG. 13, the notice from the electric appliance (electric heater) to the central control unit includes status (status), cycle period (period_msec), and on-required time period (on_required_msec).

Referring to (B) of FIG. 13, the notice transmitted from the central control unit to the electric appliance (electric heater) includes cycle period (period_msec), the start time of on-permission (on_start_msec) and the end time of on-permission (on_end_msec).

The start time of on-permission (on_start_msec) and end time of on-permission (on_end_msec) are represented as relative time in the cycle period. By way of example, the setting of cycle period (period_msec) of 1 minute, the start time of on-permission (on_start_msec) of 10 seconds and the end time of on-permission (on_end_msec) of 35 seconds means that on operation is permitted from the 10 to 35 th second in any one minute.

It may be the case that on_start_msec>on_end_msec. Assume, for example that the start time of on-permission (on_start_msec) is set to 45 seconds and the end time of on-permission (on_end_msec) is set to 10 seconds. Here, it means that on operation is permitted from every 45 th second of any one minute to the 10 th second of the next minute.

In the present embodiment, of the instruction sent from central control unit 101 to the electric appliance (electric heater), the cycle period (period_msec) and the end time of on-permission (on_end_msec) may be omitted. The reason for this is that the cycle period (period_msec) is already known by the electric appliance (electric heater), and the end time of on-permission (on_end_msec) can be calculated.

The end time of on-permission (on_end_msec) can be calculated in accordance with the following equation.

on_end_msec=(on_start_msec+on_required_msec) % period_msec)

In the present specification, the symbol “%” in the equation represents an operator for finding a remainder. For example, “a % b” represents the remainder when a is divided by b.

It is assumed that central control unit 101 and each of the electric appliances run on common time. The common time is managed by time synchronizing unit 307. By way of example, electric appliance control unit 301 of electric heater 111 obtains current time from time synchronizing unit 307.

When the current time is given, the electric appliance determines where the current time is positioned in the cycle period, in the following manner.

Assume that the current time is h (hour) m (minutes) s (seconds) and milli (milliseconds). The time (nt) on the millisecond scale in the cycle period of one day is represented by Equation (7) below, and the remainder (nt_msec) when the time nt divided by the cycle period is the relative current time in the cycle period.

nt=(h*3600+m*60+s)*1000+milli (7)

nt_msec=nt % period_msec (8)

A method of determining whether or not the current time is in the on-permitting time period will be described. It is noted that two different methods are used depending on positional relation between the start time and end time of on-permitting time period.

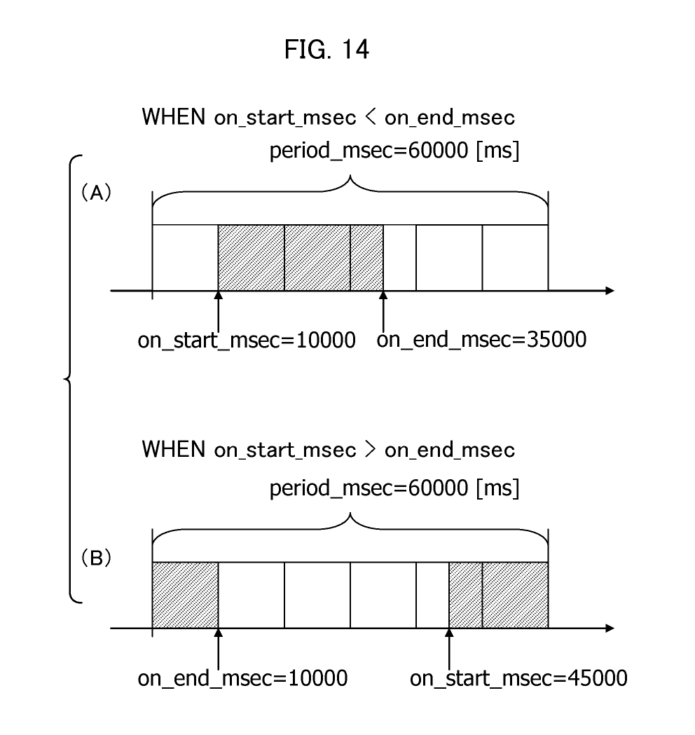

Referring to (A) of FIG. 14, if the relation on_start_msec<on_end_msec is satisfied, it is determined to be within the on-permitting time period if the following equation holds, and otherwise, it is determined to be out of the on-permitting time period.

nt_msec>=on_start_msec && nt_msec<on_end_msec (E1)

where the operator “&&” represents logical product. If it is in the on-permitting time period, the remaining time of on-period (on_remain) is also calculated in accordance with Equation (9) below. If it is out of the on-period, the time until it becomes on next time (on_expect) is calculated in accordance with Equation (10) below.

on_remain=on_end_msec−nt_msec (9)

on_expect=(on_start_msec−nt_msec+period_msec) % period_msec (10)

Referring to (B) of FIG. 14, when on_start_msec>on_end_msec is satisfied, it is determined to be within the on-permitting time period if the following equation holds, and otherwise, it is determined to be out of the on-permitting time period.

nt_msec>=on_start_msec∥nt_msec<on_end_msec (E2)

where operator “∥” represents a logical sum. If it is in the on-permitting time period, the remaining time of on-period (on_remain) is also calculated in accordance with Equation (11) below. If it is out of the on-period, the time until it becomes on next time (on_expect) is calculated in accordance with Equation (12) below.

on_remain=(on_end_msec−nt_msec+period_msec) % period_msec (11)

on_expect=on_start_msec−nt_msec (12)

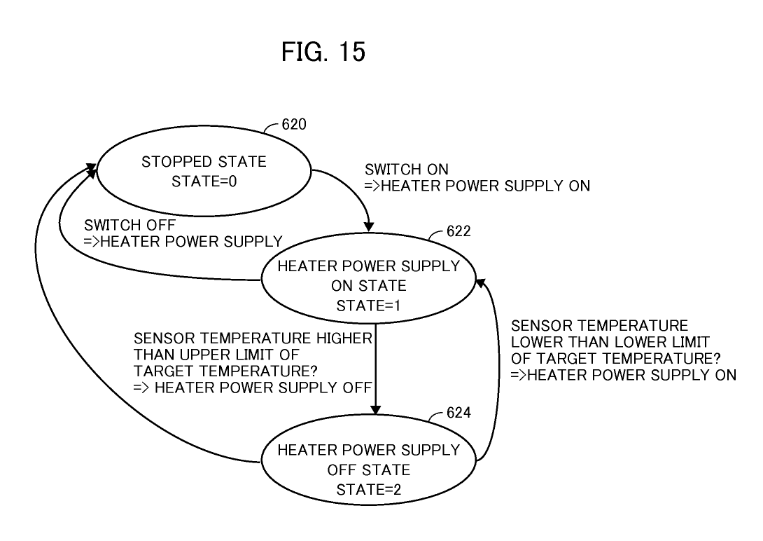

FIG. 15 shows, for comparison with the present embodiment, a transition diagram of internal status of a conventional electric appliance (electric heater). The conventional electric heater has three internal states, that is, stopped state 620, heater power-supply-on state 622 and heater power-supply-off state 624. The initial state is the stopped state. In the present specification and in the drawings, a state variable STATE is used to represent the internal status of the electric appliance. The value of state variable STATE changes depending on the internal status.

Referring to FIG. 15, if switched on while it is in the stopped state 620 (STATE=0), power supply to the heater is turned on, and the state makes a transition to the heater power-supply-on state 622 (STATE=1). If it is detected in the heater power-supply-on state 622 that the sensor temperature has exceeded the upper limit of target temperature, power supply to the heater is turned off, and the state makes a transition to the heater power-supply-off state 624 (STATE=2). If it is detected in the heater power-supply-off state 624 that the sensor temperature has become lower than the lower limit of target temperature, power supply to the heater is turned on, and the state makes a transition to the heater power-supply-on state 622. If it is switched off in the heater power-supply-on state 622 or the heater power-supply-off state 624, power supply to the heater is turned off, and the state makes a transition to the stopped state 620 (STATE=0).

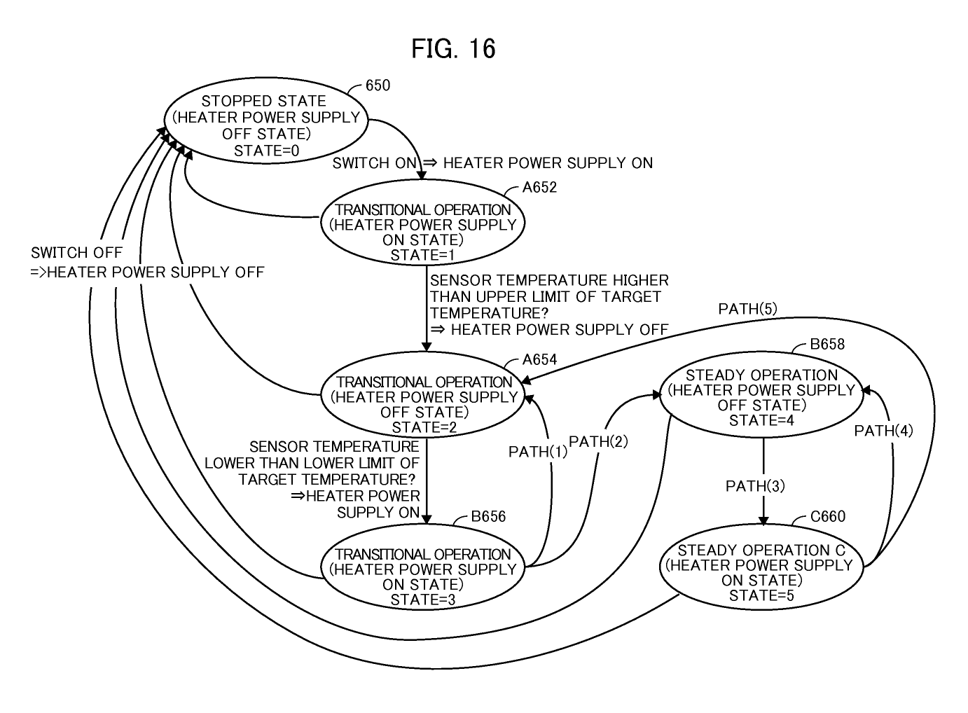

FIG. 16 shows a transition diagram of internal status of electric appliance (electric heater) in accordance with the present embodiment. Here again, state variables STATE similar to those of FIG. 15 are used. The internal statuses of electric appliance include six states, that is, stopped state 650 (STATE=0), heater power-supply-on state A 652 (STATE=1), heater power-supply-off state A 654 (STATE=2), heater power-supply-on state B 656 (STATE=3), heater power-supply-off state B658 (STATE=4), and heater power-supply-on state C 660 (STATE=5).

Of these states, heater power-supply-on state A 652, heater power-supply-off state A 654 and heater power-supply-on state B 656 can be regarded as transitional states. Heater power-supply-off state B 658 and heater power-supply-on state C 660 can be regarded as the steady status.

Basic operations of the electric appliance in accordance with the present embodiment are the same as in the conventional art. The electric appliance in accordance with the present embodiment has additional operations as follows.

If it is detected in the heater power-supply-on state B 656 that the sensor temperature has exceeded the upper limit value of target temperature, whether or not immediately preceding cycle period is sufficiently close to the target cycle period is determined. If it is sufficiently close, the state makes a transition to the heater power-supply-off state B 658 (path 2). Otherwise, the state returns to the heater power-supply-off state A 654 (path 1).

If it is detected in the heater power-supply-off state B 658 that the sensor temperature has become lower than the lower limit of target temperature, power supply to the heater is turned on, and the state makes a transition to the heater power-supply-on state C 660 (path 3).

If it is detected in the heater power-supply-on state C 660 that the sensor temperature has exceeded the upper limit of target temperature, power supply to the heater is turned off, and the state makes a transition to the heater power-supply-off state B 658 (path 4). If the immediately preceding cycle period comes to be not sufficiently close to the target cycle period, the state returns to the heater power-supply-off state A 654 (path 5).

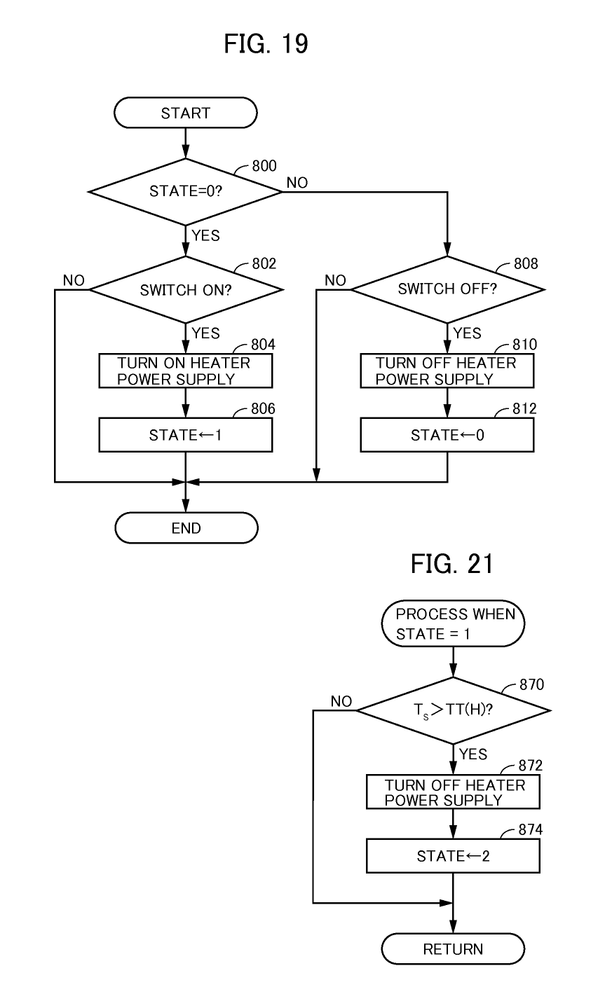

Actually, conditions to pass through paths 3, 4 and 5 are slightly more complicated, as the operation timing instruction is issued from central control unit 101. Details will be described with reference to the flowcharts of FIGS. 19 to 25.

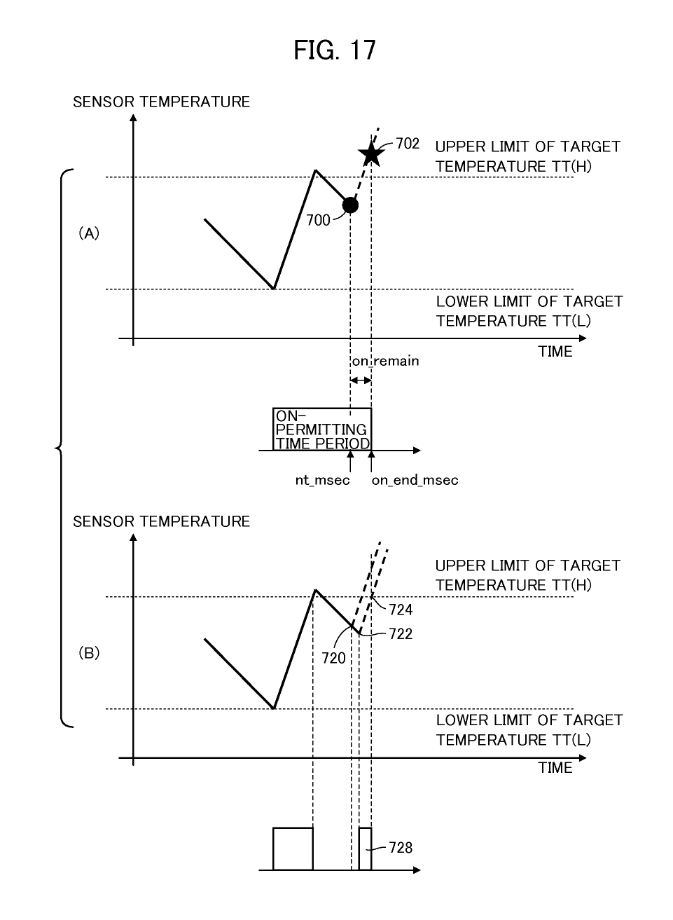

Referring to FIG. 17, one of the conditions causing transition from the heater power-supply-off state B 658 to the heater power-supply-on state C 660, that is, “timing to turn on reached” will be described. For easier understanding, it is assumed that currently the state is heater-power-supply-off state and it is within the on-permitting time period. That the current time is within the on-permitting time period does not always mean that power supply must be turned on. In the present embodiment, if the temperature is higher than the upper limit of target temperature, power supply to the heater is always turned off. The reason for this is that maintaining the sensor temperature within the range of target temperature is of higher priority than to follow the instruction. It is of importance that at timing when the on-permitting time period ends, the temperature is kept as high as possible, so as to prevent turning on of power supply outside the on-permitting time period. For this purpose, the temperature is controlled such that the sensor temperature comes close to the upper limit of target temperature at the end of on-permitting time period.

Referring to (A) of FIG. 17, the current state is indicated by a point 700. The current time is nt_msec (within on-permitting time period) as indicated at a lower portion of (A) of FIG. 17, and it is assumed that the on-permitting time period ends at the time point on_end_msec (end time of on-permitting time period). Expected temperature at the end time of on-permitting time period on_end_msec when power supply to the heater is supposed to be started at current point 700 is indicated by expected temperature 702.

Generally, a temperature in the future (end time of on-permitting time period), that is, the temperature future_room_temp is expected in accordance with Equation (13) below.

future_room_temp=room_temp+on_remain*up_rate (13)

where room_temp represents the current sensor temperature, on_remain represents remaining time of on-period, and up_rate represents the rate of temperature increase. The rate of temperature increase up_rate is calculated beforehand, based on past results.

If the expected temperature future_room_temp is equal to or lower than the upper limit of target temperature, the current point 700 is determined to be timing to turn on. In this manner, it becomes possible to have the temperature at the end time of on-permitting time period substantially the same as the upper limit of target temperature. As a result, the possibility that the temperature decreases to be lower than the lower limit of target temperature in the off-period can be reduced.

For instance, in the example shown in (B) of FIG. 17, assume that a time point 720 is within the on-permitting time period shown in (A) of FIG. 17. The future temperature at the end of on-period expected at time point 720 is higher than the upper limit TT(H) of target temperature. Therefore, the time point 720 is not the timing to turn on, and hence, transition to the heater power-supply-on state C 660 does not take place. On the other hand, if the temperature at the end of on-period is predicted at time point 722 of (B) of FIG. 17, the expected temperature is equal to or lower than the upper limit TT(H) of target temperature. Therefore, at time point 722, transition from the heater power-supply-off state B 658 to the heater power-supply-on state C 660 takes place. As a result, the temperature at the end of on-period (on_end_msec) would be equal to or lower than the upper limit TT(H) of target temperature.

From the foregoing, it is understood that the on-period 728 of power supply to the heater is from time point 722 to time point 724.

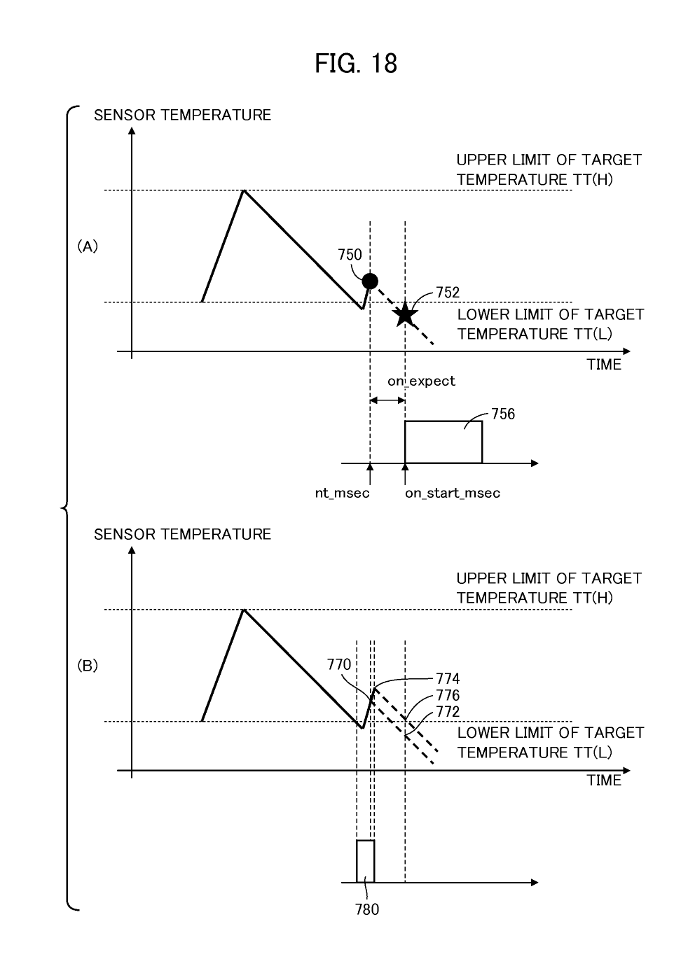

One of the conditions causing transition from the heater power-supply-on state C 660 to the heater power-supply-off state B 658 is a condition “on must be continued against instruction.” The meaning of this condition will be described with reference to FIG. 18. For easier understanding, it is assumed that the current time point 750 corresponds to the heater-power-supply-off state, and it is out of the on-permitting time period. That the current time is out of the on-permitting time period does not mean that power supply should never be turned on. In the present embodiment, if the temperature is lower than the lower limit of target temperature, power supply to the heater is always turned on. The reason for this is that maintaining the sensor temperature within the range of target temperature is of higher priority than to follow the instruction. Keeping the supply on outside the on-permitting time period, however, should be for as short a time period as possible. Therefore, the following control is executed, in order that the sensor temperature does not become lower than the lower limit of target temperature until the start time of the next on-permitting time period.

Referring to (A) of FIG. 18, assuming that power supply to the heater is turned off at a current time point A, the expected temperature 752 (future_room_temp) at the start time of on-permitting time period of the next on-permitting time period 756 is expected in accordance with Equation (14) below.

future_room_temp=room_temp+on_expect*down_rate (14)

where room_temp represents the current sensor temperature, on_expect represents time until power supply is turned on next time, and down_rate represents the rate of temperature decrease. The rate of temperature decrease down_rate is calculated beforehand based on past results.

Electric appliance control unit 301 of electric heater 111 determines that power supply should be kept on against the instruction if the expected temperature 752 future_room_temp shown in (A) of FIG. 18 is equal to or lower than the lower limit of target temperature. Otherwise, electric appliance control unit 301 determines that the power supply should not be kept on.

Specifically, as shown in (B) of FIG. 18, assuming that power supply is turned off at time point 770, expected temperature 772 at the start time of next on-permitting time period is predicted, and if the expected temperature is lower than the lower limit of target temperature, power supply is kept on even outside the on-permitting time period. Such prediction is repeated, and if expected temperature 776 predicted on the assumption that power supply is turned off at a time point 774 is higher than the lower limit TT(L) of target temperature, power supply to the heater is turned off. As a result, here, heater power supply on period 780 ends at time point 774. The sensor temperature at the start time (on_start_msec) of the next on-permitting time period 756 would be higher than the lower limit TT(L) of target temperature.

<Control by Electric Appliance Control Unit 301>

In order to control electric heater 111 in the manner as described above, electric appliance control unit 301 executes a program having such a control structure as will be described in the following. Though the description below relates to control of electric heater 111, it goes without saying that the various other appliances can be controlled by programs having similar control structures.

The program controlling electric heater 111 mainly includes three programs. The first is a switch interruption program activated by an interruption signal generated when the switch is operated. The second is a heater control program periodically executed in accordance with the timer. The state variable STATE will be commonly referred to by these programs, as will be described later. The third is a program executed when any event occurs in electric heater 111.

<<Switch Interruption Program>>

Referring to FIG. 19, the switch interruption program is activated by an interruption that occurs every time the switch is operated, and it includes: a step 800 of determining whether or not the value of state variable STATE is 0; a step 802, executed if the determination at step 800 is positive, of determining whether or not the switch operation is a switch-on operation; a step 804, executed if the determination at step 802 is positive, of turning on the power supply to the heater; and a step 806, following step 804, of inputting 1 to the state variable STATE and ending the process. If the determination at step 802 is negative, the process ends.

The program further includes: a step 808, executed if the determination at step 800 is negative, of determining whether or not the operation is a switch-off operation; a step 810, executed if the determination at step 808 is positive, of turning off power supply to the heater; and a step 812 of inputting 0 to the state variable STATE and ending the process. If the determination at step 808 is negative, the process ends.

<<Heater Control Program>>

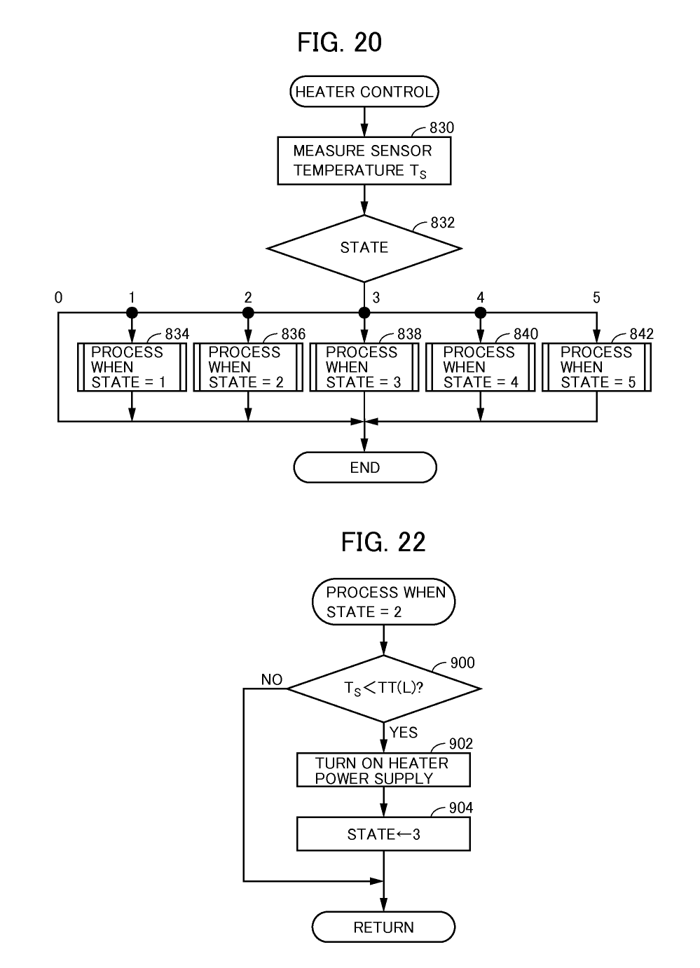

Referring to FIG. 20, the heater control program periodically executed in accordance with the timer includes: a step 830 of measuring sensor temperature Tₛ; a step 832, following step 830, of branching the process in accordance with the value of state variable STATE; and steps 834, 836, 838, 840 and 842, executed if the value of state variable STATE is 1, 2, 3, 4 and 5, respectively. If the value of state variable STATE is 0, or after the end of process steps 834, 836, 838, 840 and 842, execution of the heater control program ends. The heater control program is executed, for example, at every other second.

(1) If the state variable STATE=0

No process is executed.

(2) If the state variable STATE=1

The process of step 834 of FIG. 20 is executed. More specifically, referring to FIG. 21, whether or not the sensor temperature TS is higher than the upper limit TT(H) of target temperature is determined (870). If the determination is positive, power supply to the heater is turned off at step 872, state variable STATE is set to “2” at step 874, and the process ends. If the determination at step 870 is negative, the process ends.

(3) If the state variable STATE=2

Here, referring to FIG. 22, at step 900, whether or not the sensor temperature TS is lower than the lower limit TT(L) of target temperature is determined. If the determination is positive, power supply to the heater is turned on at step 902, 3 is input to the state variable STATE at step 904, and the process ends. If the determination at step 900 is negative, the process ends without any operation.

(4) If the state variable STATE=3

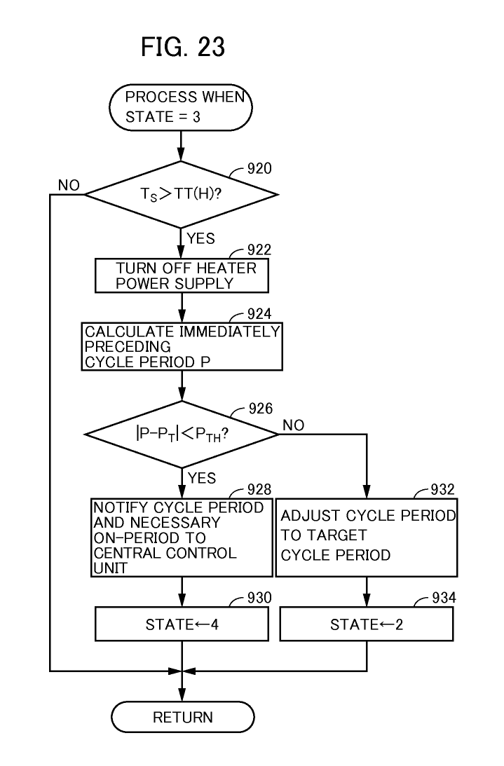

Referring to FIG. 23, at step 920, whether or not the sensor temperature TS is higher than the upper limit TT(H) of target temperature is determined. If the determination is negative, the process ends. If the determination is positive, at step 922, power supply to the heater is turned off, and the immediately preceding cycle period P is calculated at step 924. The cycle period can easily be calculated based, for example, on control history information or the like of the electric appliance. The target cycle period is represented as P_{T}. Thereafter, at step 926, whether or not an absolute value of difference between the cycle period P and the target cycle period P_{T} is smaller than a prescribed threshold value P_{TH} is determined. If the determination is positive, at step 928, the cycle period P and the on-period necessary to maintain the cycle period are notified to central control unit 101. Thereafter, at step 930, 4 is input to the state variable STATE and the process ends. If the determination at step 926 is negative, at step 932, the cycle period of electric heater 111 is set to the target (the target range is changed). Specific means is as described with reference to FIG. 10. Thereafter, at step 934, 2 is input to the state variable STATE and the process ends.

(5) If the state variable STATE=4

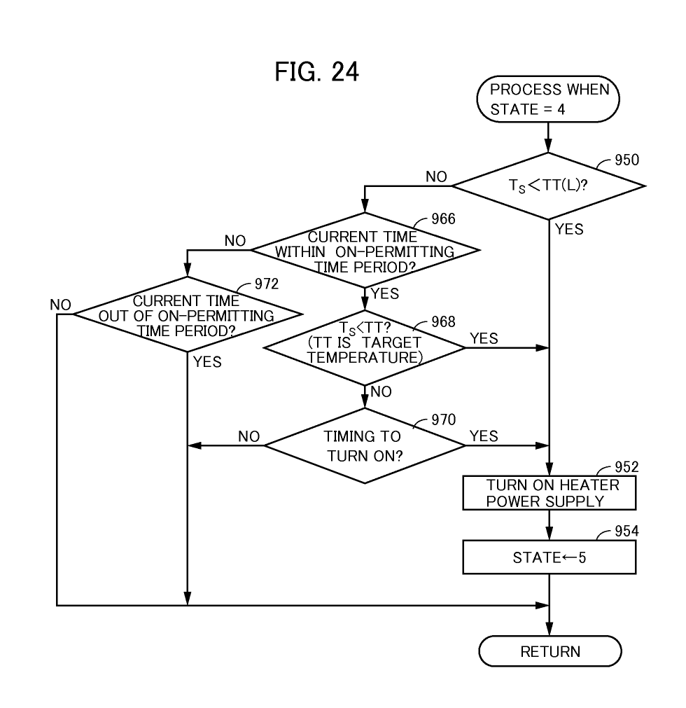

Referring to FIG. 24, at step 950, whether or not the sensor temperature TS is lower than the lower limit TT(L) of the target temperature is determined. If the determination is positive, power supply to the heater is turned on at step 952, 5 is input to the state variable STATE at step 954, and the process ends.

If the determination at step 950 is negative, at step 966, whether or not the current time is within the on-period is determined. If the determination is positive, at step 968, whether or not the sensor temperature TS is lower than the target temperature TT is determined. If the determination is positive, the control proceeds to step 952, and the process described above takes place. If the determination is negative, at step 970, whether or not the current time is the timing to turn on is determined. The substantial contents of this determination are as described above. If the determination is positive, the control proceeds to step 952. If it is negative, the process ends without any operation.

If the determination at step 966 is negative, at step 972, whether it is out of the on-permitting time period is determined. In the present embodiment, regardless of the result of determination at step 972, the process ends without any operation.

(6) If the state variable STATE=5

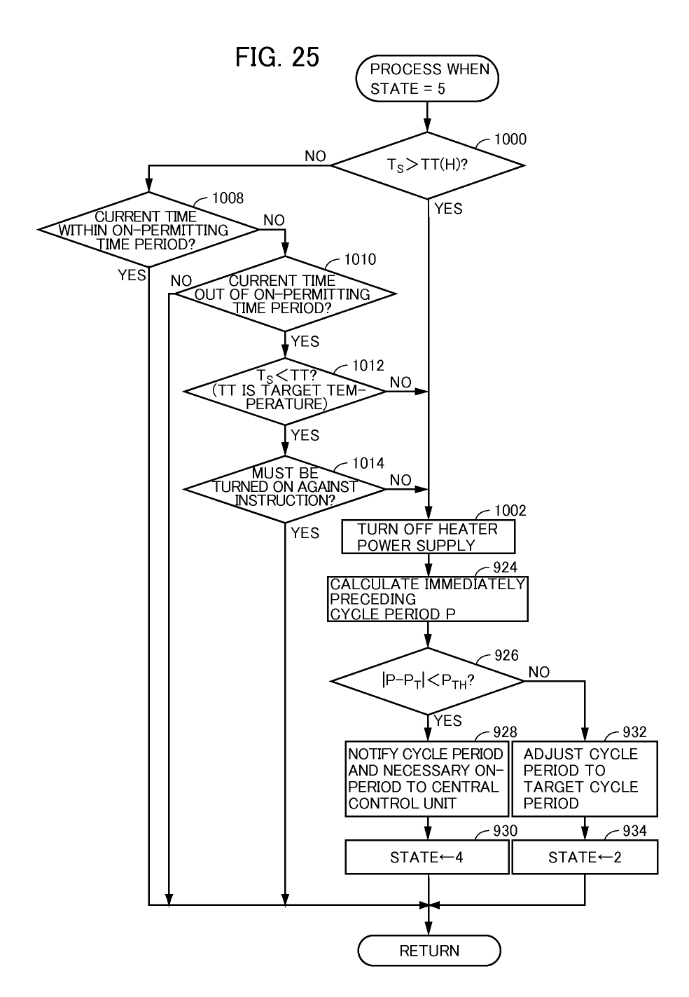

Referring to FIG. 25, at step 1000, whether or not the sensor temperature TS is higher than the upper limit TT(H) of the target temperature is determined. If the determination is positive, power supply to the heater is turned off at step 1002. The process of following steps 1020-1030 is the same as that of steps 924-934 shown in FIG. 23.

If the determination at step 1000 is negative, at step 1008, whether or not the current time is within the on-permitting time period is determined. If the determination is positive, the process ends without any operation. If the determination is negative, at step 1010, whether the current time is within the on-permitting time period is further determined. If the determination is negative, the process ends without any operation. If the determination is positive, at step 1012, whether the sensor temperature TS has become lower than the target temperature TT is determined. If the determination is negative, the control proceeds to step 1002, and the process described above is executed. If the determination is positive, at step 1014, whether or not the power supply should be on against the instruction is determined. If the determination is positive, the process ends without any operation (while on state is maintained). If the determination is negative, the process following steps 1002 is executed, and then the process ends.

<Control of Central Control Unit 101>

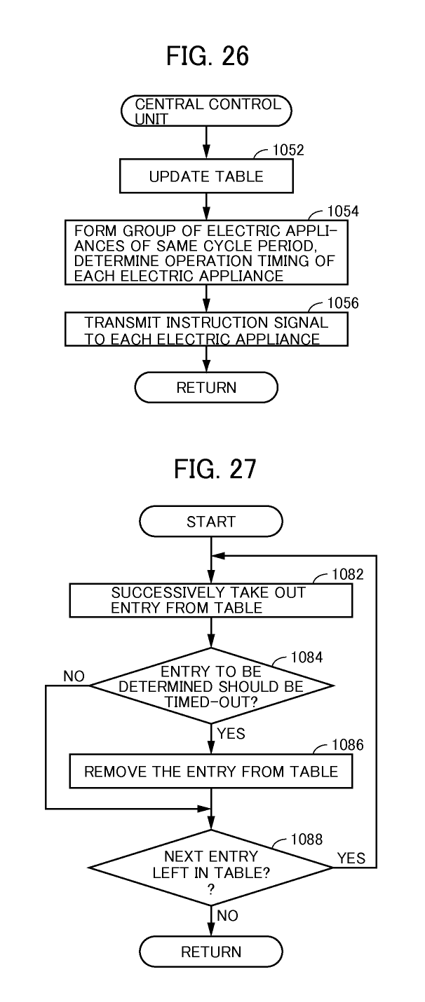

Central control unit 101 executes two processes. The first is a process started when a notice is received from the electric appliance. This process is shown in FIG. 26. The second is a process periodically executed driven by the timer. This process is shown in FIG. 27.

<<The Process Executed upon Reception of a Notice>>

Referring to FIG. 26, the program for processing the notice from the electric appliance such as electric heater 111 includes: a step 1052 of updating a table maintained by central control unit 101 for managing the electric appliance; a step 1054, following the update at step 1052, of grouping electric appliances of which cycle periods match, with reference to the table, and determining operation timing of each electric appliance; and a step 1056 of transmitting an instruction including the operation timing determined at step 1054 to each electric appliance, and ending the process.

At the table update at step 1052, an entry related to the electric appliance specified by the received contents is saved. Each electric appliance has an identification number allotted in advance. By this identification number, the entry corresponding to each electric appliance is identified. If there is already an entry having the same identification number, the entry is updated. If there is no entry of the identification number, an entry is added.

The method of determining the operation timing at step 1054 will be described later.

At step 1056, the instruction including the operation timing is transmitted to each electric appliance. Here, if the instruction has the same contents as sent last time, it is unnecessary to transmit the instruction. Therefore, central control unit 101 stores the contents transmitted at step 1056 in the storage device.

<<Timer Driven Process>>

Referring to FIG. 27, the process activated periodically by the timer has such a control structure as described in the following. Though timer interval belongs to design matter, an interval of about 1 second is sufficient. At step 1082, an entry is taken out from the table stored in central control unit 101 for managing the electric appliances. At step 1084, whether the entry should be timed-out or not is determined. Here, the time out refers to an operation of eliminating an entry for which a prescribed time has passed after reception of the last notice from the electric appliance corresponding to the entry. For this purpose, the time when the last notice is received from the electric appliance is stored in each entry of the table. Generally, latest information is periodically transmitted from the electric appliances. It is possible, however, that an electric appliance is suddenly unplugged. In such a situation, it is not preferable to maintain old information for a long time in the table. Therefore, when a prescribed time period has passed without any notice from an electric appliance, time out operation should be executed. At step 1084, if the time of latest response recorded for the entry is older than the prescribed time period from the current time, it is determined that the entry should be timed-out.

If the determination at step 1084 is positive, the entry is deleted from the table at step 1086.

If the determination at step 1084 is negative, or if the determination at step 1084 is positive and the process at step 1086 is completed, at step 1088, whether or not there is a next entry in the table is determined. If the determination is positive, the control returns to step 1082. If the determination is negative, the process ends.

<<Table Configuration>>

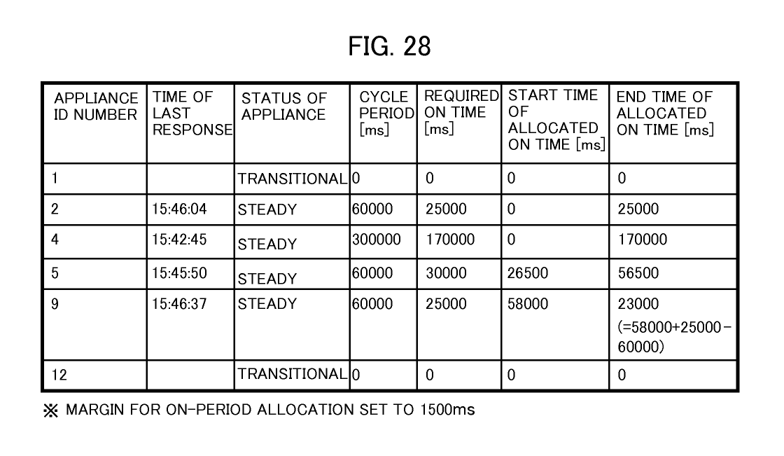

FIG. 28 shows an example of a table maintained by central control unit 101. Referring to FIG. 28, the statuses of various electric appliances are recorded in this table. Central control unit 101 must always maintain this table in the latest status. Each entry of the table includes the identification number, the latest time of response, the status of the appliance, the cycle period and the required on time period, of each electric appliance. These items are updated based on the information (notice) received by central control unit 101 from each electric appliance. Each entry of the table further includes the start time and end time of the on-period, allocated by central control unit 101 to each electric appliance.

Central control unit 101 classifies electric appliances having the same cycle period and make a group, with reference to the table. Central control unit 101 further determines, based on the result of grouping, the operation timing among the electric appliances belonging to the same group, in accordance with the policy described above. Specifically, the operation timing of each electric appliance is determined such that at timing when the on-period of one electric appliance ends, the on-period of another appliance starts.

By way of example, in FIG. 28, the entries corresponding to appliance identification numbers 2, 5 and 9 all have the same cycle period of 60000 [ms]. The on-periods required by these appliances are 25000 [ms], 30000 [ms] and 25000 [ms], respectively.

Table 1 below shows an exemplary operation timing of these appliances determined by central control unit 101.

TABLE 1

| Appliance ID number | On start time | On end time |
|---|---|---|
| 2 | 0 [ms] | 25000 [ms] |
| 5 | 26500 [ms] | 56500 [ms] |
| 9 | 58000 [ms] | 23000 [ms] |

In the example shown in Table 1, a margin of 1500 ms is provided between an on-period of one appliance and an on-period of another appliance. By way of example, between the end time (25000 [ms]) of the on-period of appliance having the identification number=2 and the start time (26500 [ms]) of the on-period of appliance having the identification number=5, there is a margin of 1500 ms. This margin is provided to prevent the off timing of appliance having identification number=2 and the on timing of appliance having identification number=5 from being reversed.

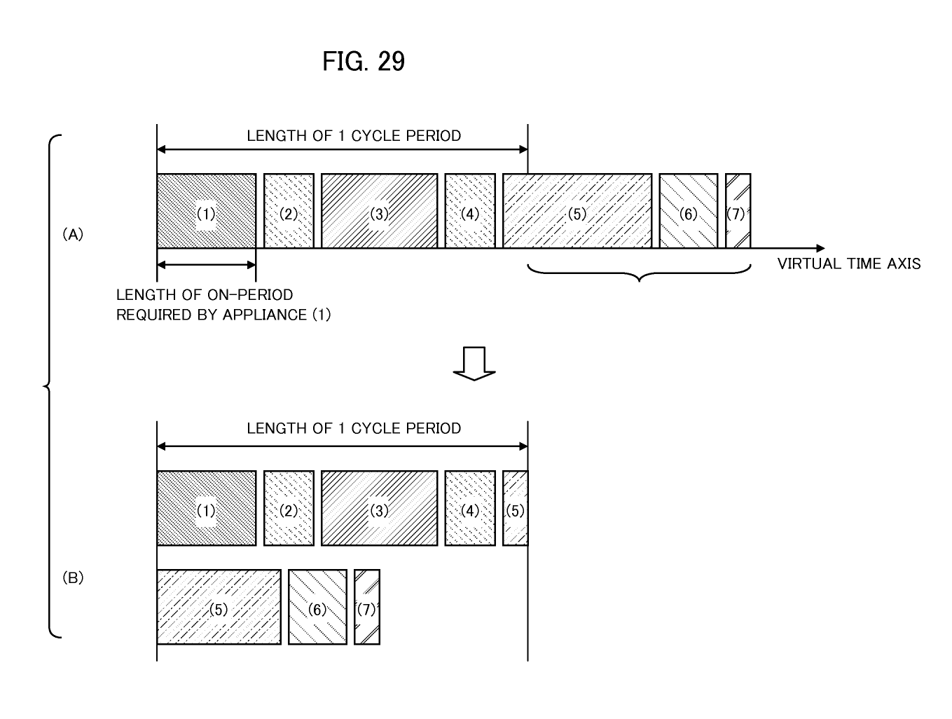

Referring to FIG. 29, an example of the method of allocating the on-period to each appliance, executed by central control unit 101, will be described. Here, it is assumed that appliances (1) to (8) have the same cycle period, and each requires its on-period. The required on-period may be or may not be the same.

Here, as shown in (A) of FIG. 29, central control unit 101 successively places the on-periods required by appliances (1) to (8) on a virtual time axis. Here, some margin should preferably be ensured between the on-period of one appliance and the on-period of another, as described above.

In this allocation for appliances (1) to (8), if the on-period of any electric appliance exceeds the length of one cycle period, the exceeding portion is moved to the next cycle period. This operation is repeated. Actually, a value obtained by accumulating the cycle periods of electric appliances is divided by the cycle period, to find the reminder.

In the example shown in FIG. 29, it can be seen that there is a time period in which appliances (1) and (5) are both on. Similarly, there is also time periods in which appliances (5) and (2), (2) and (6), (6) and (3), (3) and (7) etc. are both on.

In the present embodiment, if a new appliance is added, an on-period is added following the appliance at the tail. If an existing apparatus (denoted as appliance (K)) is removed, the on-period of the appliance (K) is deleted on the virtual time axis, and the on-period of the appliance (K+1) and following appliances is shifted forward. For the appliance K+1 and the following of which scheduling has been changed, an operation timing instruction is transmitted. If the on-period of an existing appliance (appliance (K)) is changed, the on-period of appliance (K) is changed on the virtual time axis, and the on-period of appliance (K+1) and following appliances is shifted forward/backward. To the appliance (K) and appliance (K+1) and following appliances of which scheduling has been changed, the operation timing instruction is transmitted.

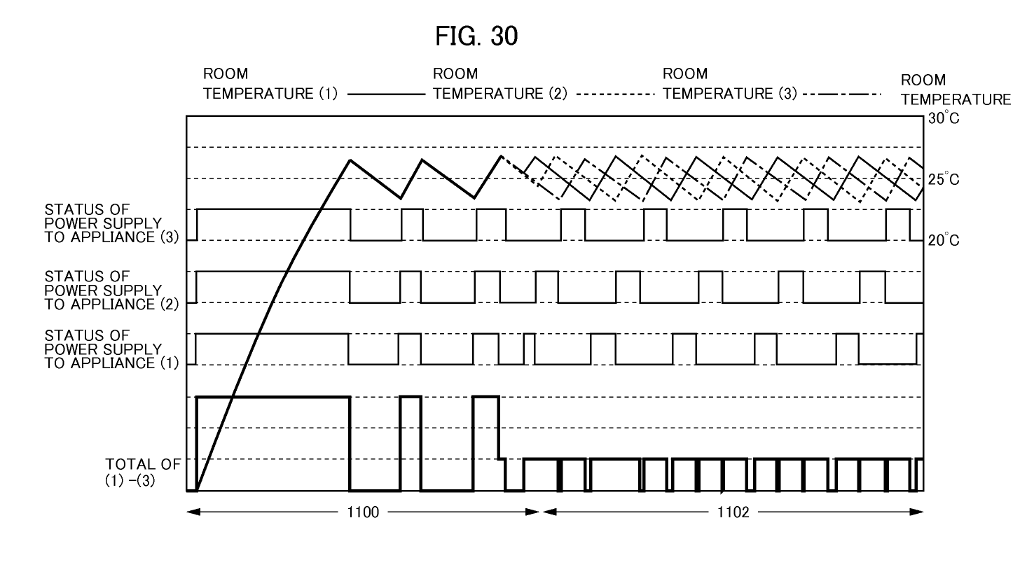

FIGS. 30 and 31 show results of computer simulation of the system in accordance with the present embodiment. These figures show results when the same number of appliances having the same cycle period (60 sec.) are operated with different duty ratios (0.32 in FIG. 30 and 0.65 in FIG. 31).

Referring to FIG. 30, when three appliances having the cycle period of 60 seconds and duty ratio of 0.32 are operated, in transitional status 1110, it is possible that three appliances operate simultaneously. In the steady status 1102, however, the appliances operate in a coordinated behavior, so that it becomes possible to prevent two appliances from being on simultaneously. Specifically, in the steady status, only one appliance is on at any time point.

Referring to FIG. 31, when three appliances having the cycle period of 60 seconds and duty ratio of 0.65 are operated, in transitional status 1120, it is possible that three appliances operate simultaneously. In the steady status 1122, however, the appliances operate in a coordinated behavior, so that it becomes possible to prevent three appliances from being on simultaneously. Specifically, in the steady status, up to only two appliances are on at any time point.

As described above, by realizing the coordinated operation of various electric appliances, the total sum of power consumption in the steady status can be reduced.

### Second Embodiment

The system in accordance with the second embodiment assumes that each electric appliance involves temperature control (on/off control) such as a heater, and that the electric appliances consume different quantities of electric power. In the following description and in the drawings, the same components as those described in the first embodiment are denoted by the same reference characters, and they have the same names and functions. Therefore, detailed description thereof will not be repeated.

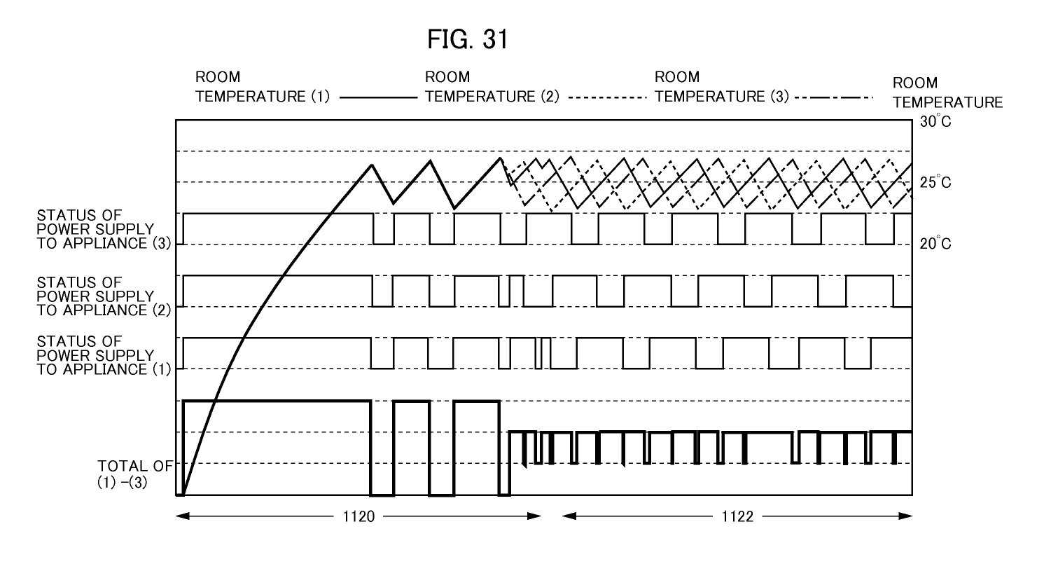

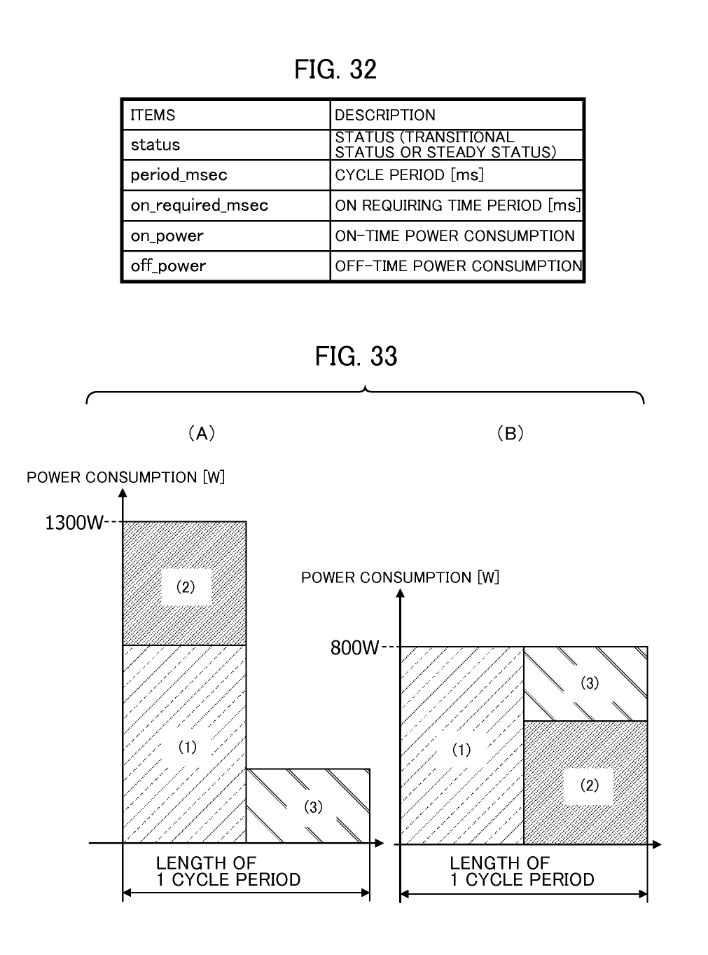

FIG. 32 shows contents of the notice sent from the electric appliance (electric heater) to the central control unit, in accordance with the present embodiment. The notice shown in FIG. 32 includes, in addition to the contents of the notice shown in (A) of FIG. 13, the following two items: (1) power consumption in the on-period (on_power); and (2) power consumption in the off-period (off power), of each electric appliance. In the following, these will be described. Though the off-period power consumption is not absolutely necessary, it is added to enhance general versatility of the system. Actually, in some appliances, the off time power consumption is not zero. Therefore, by taking into consideration the off time power consumption, control that can more accurately reduce the peak power of the overall system can be well-maintained.

In the present embodiment, it is assumed that the on-period power consumption and the off-period power consumption of the electric appliance (electric heater) are known in advance. It is preferred that the power consumption of each appliance is measured in the development status of the appliance, and programmed beforehand. It is also possible to have the electric appliance itself adapted to measure the power consumption, or to use a different measurement unit to measure the power consumption.

Except for this point, the electric appliance (electric heater) is the same as those used in the first embodiment.

In the present embodiment, the method of determining the operation timing executed by the central control unit is different from that of the first embodiment. Specifically, in the present embodiment, the power consumption is notified from each electric appliance and, therefore, the central control unit determines the operation timing of each electric appliance considering the power consumption of each electric appliance.

By way of example, let us consider control of three appliances (1) to (3) below.

TABLE 2

| Identification number | Power consumption | Duty ratio |
|---|---|---|
| 1 | 800 W | 0.5 |
| 2 | 500 W | 0.5 |
| 3 | 300 W | 0.5 |

Since the sum of duty ratios is 1.5, occurrence of a time period in which two of the appliances are simultaneously on is unavoidable. The peak power, however, can be reduced by realizing coordinated operations of these appliances.

Referring to (A) of FIG. 33, if electric appliances (1) and (2) are on at the same time, the peak power will be 1300 W. In contrast, if on timings of these appliances are adjusted such that electric appliances (2) and (3) are on simultaneously while electric appliance (1) is on always by itself, the peak power can be reduced to 800 W. Namely, depending on the combination of electric appliances, the peak power is changed. The operation timings should be determined such that the peak power becomes as low as possible, considering power consumption of each electric appliance.

It will be convenient if such operation timings can be found easily. If the number of electric appliances is small (for example, up to about 10), it may be possible to find the optimum solution. The algorithm for determining the operation timings is a problem of combination and, typically, it is difficult to find the optimum solution in a short period of time. If the number of electric appliances increases, the number of combinations would explode and, therefore, it becomes extremely difficult to find the optimum solution in a short period of time. In the present embodiment, a solution that can reduce the peak power as low as possible and that can be found in a short period, though not necessarily be the optimum solution, is adopted.

In the present embodiment, in order to determine the operation timing of each electric appliance, first, time resolution is found. Here, the time resolution refers to the minimum unit of discrete value if the continuous amount of time is regarded as discrete values. If the time resolution is made large (rough), the number of combinations can be reduced and, therefore, the computational time can be reduced. By way of example, the resolution of 5 seconds (=5000 ms) will be used, rather than the order of 1 ms.

Assume that the electric appliance has the cycle period of 60 seconds. Then, there are 12 different timings (60 seconds/5 seconds) of activation of the electric appliance. When there are 10 electric appliances, generality would not be lost even if we assume that the first appliance is always powered on at 0th second.

Here, the number of combinations of operation timings of the second to 10th appliances is 12⁹=5159780352. It may be impossible to calculate combinations of this order on real time basis by an embedded CPU.

Generally, when there is N appliances, the computational amount would be O(c^{N}), where C=cycle period/resolution. The computational amount increases exponentially as the number N increases. Though the number of combinations may be reduced to some extent by pruning, essential difficulty is the same. Therefore, the present embodiment seeks to find not the optimum solution but an approximation (close to the optimum solution) on real time basis.

In the present embodiment, the operation timing of each electric appliance is determined in accordance with the following algorithm. The number of appliances is N. These appliances will be denoted as appliance (1) to (N).

Regarding appliance (1), if it is assumed that it starts operation from 0 second, generality is not lost. The operation timings of appliances (2) and so on are determined in the following manner.

Specifically, electric appliances (2) to (N) are allocated in this order in one cycle period. By the time an electric appliance (k) is to be allocated, the allocation up to electric appliance (k−1) would have already been determined. If the operation timing of electric appliance (k) is to be allocated, the position of allocation of appliance (k) is determined such that the difference between the top peak electric power (the value at which the sum of electric powers becomes the highest) and the bottom peak electric power (the value at which the sum of electric powers becomes the lowest) becomes as small as possible. Typically, if a period in which one appliance is allocated and a period in which another appliance is allocated are selected not to overlap with each other, the peak power consumption can be reduced at least than when the periods in which these two appliances are allocated are overlapped. It is naturally necessary to see the allocation of all electric appliances. If the number of appliances is three or more, overlap would be unavoidable. Even in that case, there must be one set of (two) electric appliances allocated not to overlap with each other.

Assume that operation timings of appliances (1) to (k−1) are determined. In this situation, consider allocation of appliance (k). Specifically, appliance (k) is tentatively allocated at each timing determined by the resolution, in one cycle period. As a result, the top peak power and the bottom peak power in one cycle period can both be calculated. The difference between these is calculated. Such an operation is executed for each of the timings described above. Among the operation timings, the position of one that realizes the smallest difference between the top peak power and the bottom peak power is selected. If there is a plurality of such operation timing positions, one closer to the head of cycle period is selected.

Considering the cycle period and the resolution, the number of timings at which appliance (k) can be allocated corresponds to cycle period/time resolution. Here, this number is denoted as M. The calculation of difference between the top peak power and bottom peak power described above is repeated M times for one appliance. The number of electric appliances of which operation timings are to be determined is N−1, that is, (2) to (N). Since M is a constant, the order of computational amount is O(N). Therefore, even if the number of electric appliances increases, the time for computation is not exponentially increased.

In this method, the order of allocating the appliances is relatively important. One preferable method is to determine the operation timings of appliances starting from the one having the largest power consumption. Another possible method is to place the appliances starting from one of which product of power consumption and required on-period is the largest. Though such methods do not provide the optimum solution, it has been confirmed by computer simulation that solutions closer to the optimum solution can be provided.

Therefore, in the present embodiment, the appliances are sorted in descending order of the power consumption (or the product of power consumption and the required on-period) to form a list of appliances (1) to (N), and the operation timings of the appliances are determined in order one by one, starting from the top of the list.

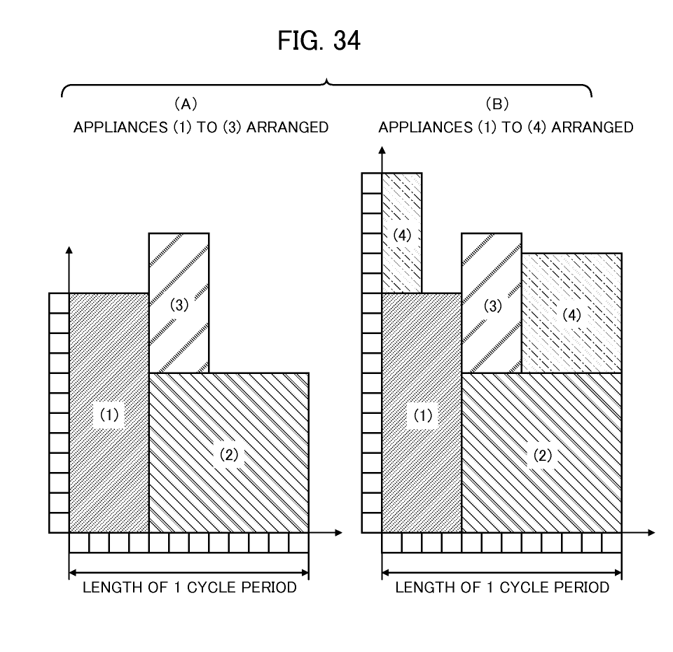

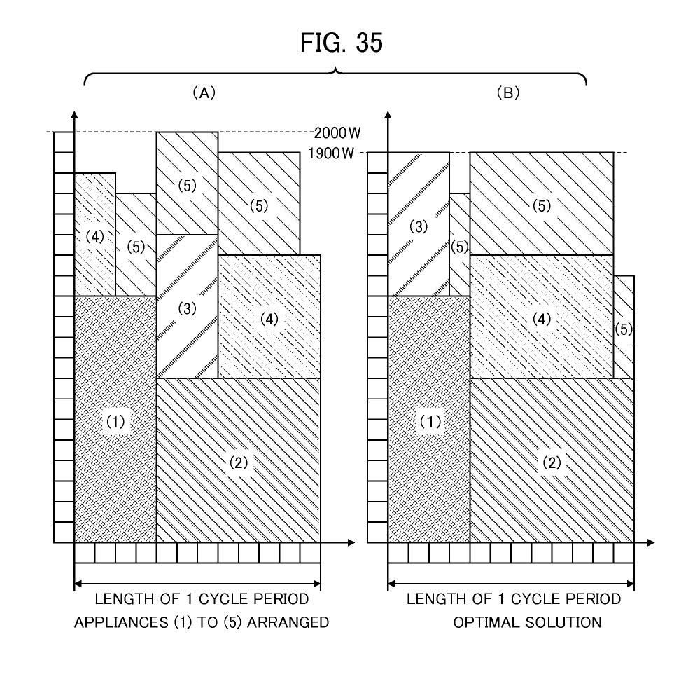

FIGS. 34 and 35 show specific examples of operation timing determination in accordance with the present embodiment. In this example, it is assumed that the cycle period is 60 seconds and the resolution is 5 seconds. There are 12 positions where the appliances can be allocated. There are electric appliances 1 to 5, of which power consumption and required on-period are as shown in the table below.

TABLE 3

| Identification number | Power consumption | Required on-period |
|---|---|---|
| 1 | 1200 W | 20 sec. |
| 2 | 800 W | 40 sec. |
| 3 | 700 W | 15 sec. |
| 4 | 600 W | 35 sec. |
| 5 | 500 W | 45 sec. |

As shown in Table 3, appliances (1), (2), . . . (5) are sorted in descendent order by power consumption. These appliances are allocated one by one in order in the following manner.

(1) Appliance (1)

Appliance (1) may be allocated at any position within the cycle period. In this example, it is assumed that the on timing of appliance (1) is at the head (0 sec.) of the cycle period. Therefore, appliance (1) operates from 0th to 20th seconds of every minute.

(2) Appliance (2)

As to appliance (2), with appliance (1) already allocated, it is positioned tentatively on each of the 12 positions, and the difference between the top peak power and the bottom peak power at each position is calculated. Appliance (2) is allocated to that one of these 12 positions at which the calculated difference is the smallest. The position selected as a result of this calculation is where appliance (2) turns on after 20 seconds from the start of cycle period. Namely, appliance (2) is allocated at a position where it is on from 20th to 0th seconds of every minute.

Similar process is done for appliance (3). As a result it is found that the appliance should desirably be allocated from 20th to 35th seconds of every minute.

Through these processes, appliances (1) to (3) are allocated within one cycle period of 60 seconds, as shown in (A) of FIG. 34.

The position of appliance (4) is also determined in the similar manner, which position corresponds to the 35th to 10th seconds of every minute.

Similarly, for appliance (5), it is found that the appliance should desirably be allocated from 10th to 55th seconds of every minute. The status of allocation up to appliance (5) is as shown in (A) of FIG. 35.

In the example above, it can be found that peak power can be reduced to 2000 W when appliances (1) to (5) are allocated as shown in (A) of FIG. 35.

It is noted, however, that this is not the optimum solution. The optimum solution is as shown in (B) of FIG. 35, in which the peak power can be reduced to 1900 W. The optimum solution can be found by brute-force calculation of timings at which the appliances are to be allocated. As already described above, however, if the brute-force calculation is to be done, the order of computational amount is O(c^{N}) (N is the number of appliances), and if the number increases, calculation becomes extremely difficult. In contrast, the computational amount in the algorithm adopted in the example above is in the order of (O)N and, therefore, a solution close to the optimum solution can be obtained on real time basis. Thus, the algorithm is useful.

Further, in the algorithm above, it is easy to enable the allocation considering off-time power consumption. Specifically, if an appliance is added, basically, the appliance may be allocated such that the difference between the top peak power and the bottom peak power becomes the smallest, in the similar manner as described above. What is necessary is simply that the off-time power consumption is included in calculating the electric power.

It is possible that while the appliances are operating in accordance with the timing allocation of appliances calculated in accordance with the algorithm above, any of the appliances is removed. In that case, simply the corresponding appliance may be deleted. There is no influence on operation timings of other appliances.

It is noted, however, that if such addition and removal of appliances are repeated, the solution may be away from the optimum solution. In order to avoid such a problem, the operation timings may be reallocated at a certain time point. As a result, the operation timings of existing appliances may be updated, and operations with power consumption leveled with new operation timings becomes possible.

As described above, according to the present embodiment, in addition to the functions attained by the first embodiment, each electric appliance notifies the on-time power consumption and the off-time power consumption. The central control unit determines the operation timing of each electric appliance, in consideration of power consumption of each appliance. As a result, the total sum of power consumption can be reduced more effectively. The determination of operation timing of each appliance may be done by brute-force calculation of optimum solution, or by the above-described method of obtaining not the best but close solution on real time basis.

### Third Embodiment

In the third embodiment, an electric appliance involving not the simple on/off control such as the heater but various and many methods of control will be considered. Transition of power consumption of such an electric appliance consists not of simple binary values of on and off but of complicated patterns. An example of such an electric appliance is an air conditioner.

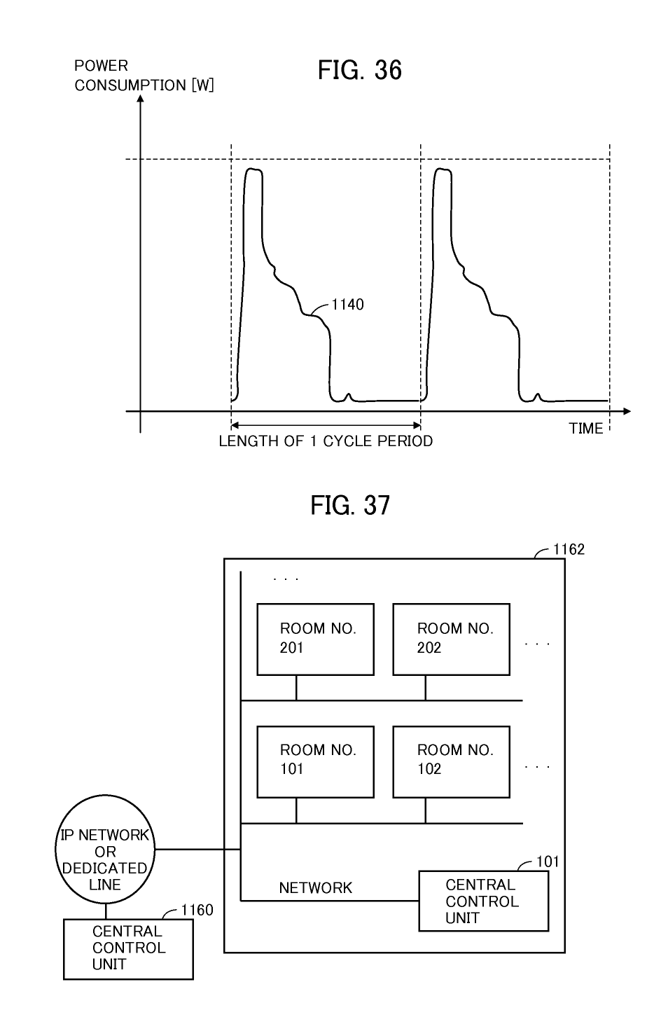

FIG. 36 shows an example of power consumption transition of an air conditioner. As can be seen from FIG. 36, the transition of power consumption of the air conditioner has a complicated pattern 1140. It is clear, however, that periodic operations are monitored. If the transition of power consumption is periodical, peak power can be reduced by the third embodiment. The present embodiment is an expansion of the second embodiment.

In the second embodiment, the notice from the electric appliance to the central control unit includes the status, cycle period, the on-required time, on-time power consumption and off-time power consumption, as shown in FIG. 32. In the third embodiment, in addition to these items, each appliance notifies the central control unit of a data sequence of discrete values, representing what electric power is required at which time within the range of one cycle period.

In the present embodiment, the “time” in “what electric power is required at which time” is represented by a relative value with the head of one cycle period being 0. Here again, the concept corresponding to the “resolution” becomes necessary. Here, it is assumed that the resolution is 1 minute and the cycle period is one hour. By way of example, the information notified to the central control unit in the third embodiment includes “required electric power at 0th minute of every hour,” “required electric power at 1st minute of every hour,” “required electric power at k-th minute of every hour,” . . . and “required electric power at 59th minute of every hour,” expressed as a data sequence.

Receiving the information, the central control unit determines the operation timing of each electric appliance utilizing the algorithm described with reference to the second embodiment.

Specifically, the central control unit allocates the electric appliances in descending order of power consumption and, starting from the top of the list, the operation timing is determined such that the difference between the top peak power and the bottom peak power is minimized. After the timings for all appliances are determined, the central control unit issues an instruction related to the operation timing to each of the appliances. Each electric appliance receives the instruction related to the operation timing from the central control unit. Receiving the instruction, each electric appliance determines its operation in accordance with the instruction. In the present embodiment, only the time when the phase of each appliance attains to 0 is notified as the operation timing. In accordance with the instruction, each electric appliance adjusts the timing such that its operation starts at the time when the phase attains to 0.

As described above, the present invention is applicable not only to the simple binary control of supplied power. The present invention is also applicable to control of power supply involving a plurality of switching operations. It goes without saying that simple control is possible if control of binary manner takes place.

### Fourth Embodiment

In the first to third embodiments, reduction of peak power consumption has been considered within the framework of one household. The present invention, however, is not limited to the above. It is also possible, for example, to reduce total peak power consumption in a unit of collective housings, a building, offices, a factory, or shops and stores in the neighborhood. By such control, the possibility of breaker tripping of the mains can be reduced while electric appliances used in each of the housings, offices, factory, stores and the like are used with originally intended usage well fulfilled, under the condition of limited capacity of mains power network.

FIG. 37 shows a configuration of a network system in a collective housing, in accordance with the present embodiment. Referring to FIG. 37, a collective housing 1162 includes a plurality of rooms (housings), a network connecting these, and a central control unit 101 similar to that of the first embodiment, connected to the network. In the present embodiment, each room represents one individual household. Electric appliances included in each room and central control unit 101 can communicate with each other through the network. Though the medium used for the network is not limited, preferably, PLC, Ethernet (registered trademark), telephone line or a cable may suitably be used. If there is existing IP network in each room, the network of collective housing 1162 may be connected thereto.

Central control unit 101 exists in collective housing 1162 in the example shown in FIG. 37. The present invention, however, is not limited to such an embodiment. For example, the central control unit may exist outside the collective housing 1162 and connected through an IP network or by a dedicated line, as represented by central control unit 1160 of FIG. 37.

In each room of collective housing 1162, a plurality of electric appliances are provided as described in the first to third embodiments. Each electric appliance is communicable to/from central control unit 101.

The difference between the system in accordance with the present embodiment and the system of the first to third embodiments is that in the present embodiment, central control unit 101 is provided not in every room but one central control unit 101 is provided for the collective housings as a whole. The function of central control unit 101 is the same as that of the first embodiment. In place of central control unit 101, the central control unit according to the second or third embodiment may be used.

In the fourth embodiment, the power consumption of electric appliances over wider scope, exceeding the unit of individual household, is leveled. In the allocation, the number of electric appliances as the controllable component increases and, therefore, the degree of freedom in allocating the operation timings of electric appliances increases. As a result, the effect of reducing the peak power consumption can more reliably be attained. Since the number of electric appliances increases, the method capable of obtaining not the optimum solution but a solution close to the optimum solution on real time basis becomes more important, as described with reference to the second embodiment.

### Fifth Embodiment

In the first to fourth embodiments above, it is assumed that the electric appliance has an ability of adjusting the cycle period in the steady status. It is not the case, however, that every electric appliance has such capability. It is desirable that the peak load of power consumption can be reduced as in the first to fourth embodiments while using conventional electric appliances as they are.

A power consumption measuring device may be utilized for such a purpose. A power consumption measuring device is described, for example, in Non-Patent Literature 2. The device described in Non-Patent Literature 2 is inserted between an electric appliance and a power source, and monitors waveforms of electricity and voltage supplied to the electric appliance, so that power consumed by the electric appliance can be measured moment to moment. By applying the power consumption measuring device to a so-called home network and collectively monitor pieces of information from various electric appliances, it is said to be possible to monitor the behavior pattern of users, to advice on energy-saving life style or to detect any defect of the electric appliances.

Further, a device that can control power supply to an electric appliance by remote instruction has also been developed.

Such a power consumption measuring device includes a small CPU as will be described later, and capable of executing a prescribed program. If the power consumption measuring device is adapted to include the components (electric appliance control unit 301, communication I/F 302, input unit 303, sensor unit 304 for measuring temperature, display unit 305, timer 306, status management unit 308, time synchronizing unit 307 and the like) for controlling the controllable component provided in each electric appliance in the first embodiment, a system similar to that of the first embodiment can be formed using conventional electric appliances. It is noted, however, that in the fifth embodiment, as in the first embodiment, the output signal of a sensor provided on the electric appliance is necessary to detect the status of operation of the electric appliance. Therefore, the power consumption measuring device in accordance with the fifth embodiment must be capable of communication to/from the electric appliance, and the electric appliance must also have a function of communicating with the outside.

A standard of electric appliances having such a function includes a so-called eco-net standard and KNX standard. An electric appliance having the function of communicating with the outside in accordance with such a standard can be used directly in the fifth embodiment.

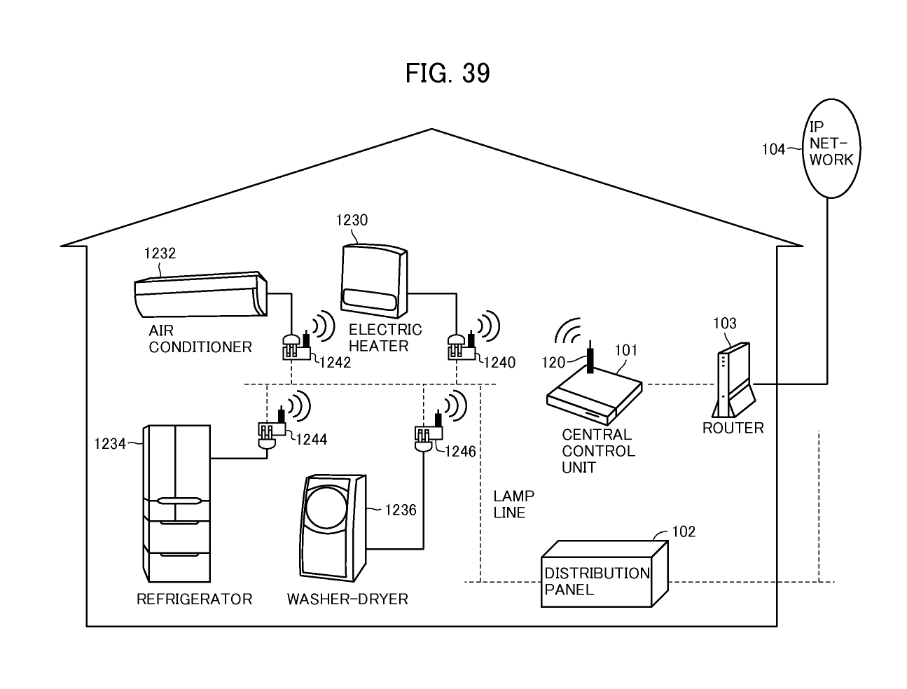

Referring to FIG. 39, the system in accordance with the fifth embodiment includes, in addition to central control unit 101, distribution panel 102, router 103 connected to IP network 104 similar to those of the system shown in FIG. 1, an electric heater 1230, an air conditioner 1232, a refrigerator 1234 and a washer-dryer 1236 all having the bi-directional communication and control functions in accordance with the standard mentioned above (for example, eco-net standard), as well as power consumption measuring devices 1240, 1242, 1244 and 1246 having a function of appliance control, inserted between a power supply inlet of lamp line and electric heater 1230, air conditioner 1232, refrigerator 1234 and washer-dryer 1236, respectively.

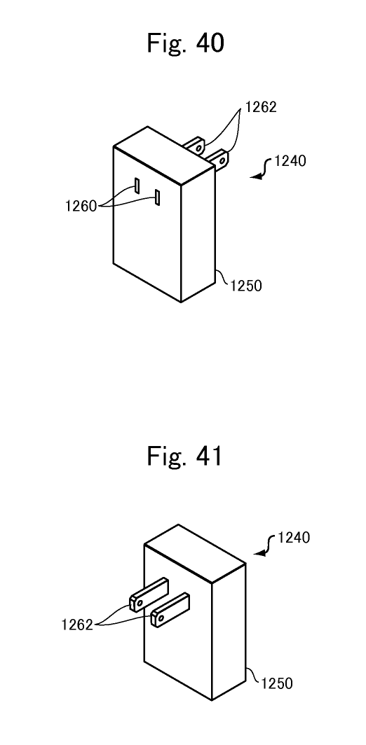

In the following, a configuration of power consumption measuring device 1240 will be described, as a representative of power consumption measuring devices 1240, 1242, 1244 and 1246. Referring to FIGS. 40 and 41, power consumption measuring device 1240 has a relatively flat, rectangular parallelepiped housing 1250, a pair of receptacle inlets 1260 provided on a front surface of housing 1250, and a pair of blades 1262 provided at positions corresponding to the receptacle inlets 1260, provided on the back surface of housing 1250.

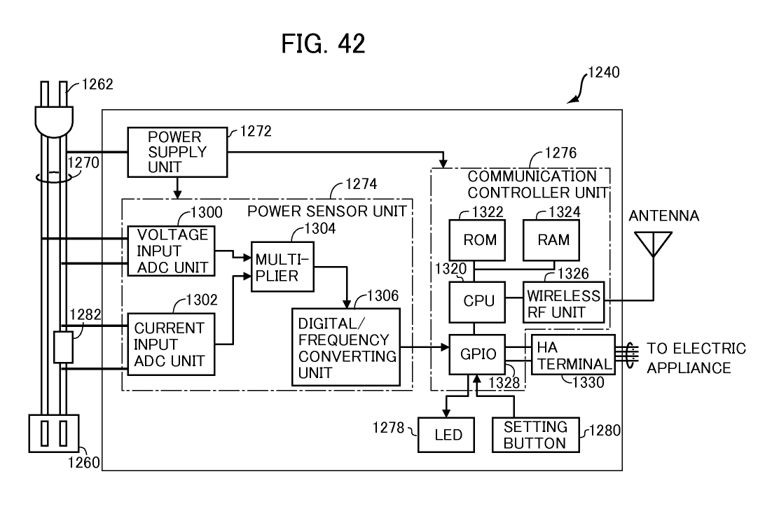

Referring to FIG. 42, power consumption measuring device 1240 further includes: a pair of lamp lines 1270 connecting receptacle inlets 1260 and blades 1262; a power supply unit 1272 receiving electric power from lamp line 1270 and supplying electric power to various portions of power consumption measuring device 1240; a power sensor unit 1274 connected to lamp line 1270 for measuring power consumption of an electric appliance connected to the pair of receptacle inlets 1260 from the current flowing through lamp lines 1270 and the voltage across two lamp lines 1270, and outputting a signal representing the magnitude of power consumption by frequency; a communication controller unit 1276, having a function of controlling the electric appliance by bi-directional communication between the electric appliance and an antenna for communication with central control unit 101 controlling electric heater 1230 based on communication of central control unit 101 and the output from power sensor unit 1274 for reducing peak power load of the system as a whole, and for controlling electric heater 1230 by communication with central control unit 101 based on the output of power sensor unit 1274; an LED 1278 and setting button 1280 (both not shown in FIGS. 40 and 41) connected to communication controller unit 1276 for displaying the status of operation of communication controller unit 1276; and an HA terminal 1330 in accordance with a standard of Japan Electrical Manufacture's Association (JEM), connected to communication controller unit 1276. HA terminal 1330 is further connected to an HA terminal of electric heater 1230.

Power sensor unit 1274 includes: a voltage input ADC unit 1300 measuring a voltage across two lamp lines 1270, converting the measurement to a digital signal and outputting the same; a shunt resistance 1282 having very small resistance value connected to one of the lamp lines 1270; a current input ADC unit 1302 measuring a current flowing through lamp line 1270 based on potential difference between positions of lamp line 1270 at opposite sides of shunt resistance 1282, converting the measurement to a digital signal and outputting the same; a multiplier 1304 receiving the output of voltage input ADC unit 1300 and the output of current input ADC unit 1302, multiplying these outputs by each other and outputting a digital power signal representing the quantity of electric power consumed by electric heater 1230; and a digital/frequency converting unit 1306 converting the digital power signal output from multiplier 1304 to a signal indicating the quantity of electric power by frequency and outputting the same. Power sensor unit 1274 is an existing electronic component and when the frequency signal output from digital/frequency converting unit 1306 is applied to an input of a power consumption meter, the power consumption meter can be driven in accordance with the power consumption. In the present embodiment, existing power sensor unit 1274 as such is used.

Communication controller unit 1276 has a configuration similar to a computer, and it includes: a CPU 1320; an ROM 1322 and an RAM 1324 both connected to CPU 1320; a wireless RF unit 1326 connected to CPU 1320, providing a function of wireless communication with central control unit 101 through an antenna; a general purpose input/output unit (GPIO) 1328 connected to CPU 1320; and a timer, not shown. The timer, which is not shown, operates in synchronization with the timer of central control unit 101 as in the first embodiment. This is necessary to determine the head of a cycle period.

To GPIO 1328, one side terminal of HA terminal 1330, the output of digital/frequency converting unit 1306, the output of setting button 1280 and an input of LED 1278 are connected.

Power consumption measuring device 1240 shown in the fifth embodiment is programmed to attain the same function as communication I/F 302, electric appliance control unit 301, input unit 303, display unit 305, timer 306, and status management unit 308 shown in FIG. 3 of the first embodiment. Setting button 1280 corresponds to input unit 303, and LED 1278 corresponds to display unit 305. Power sensor unit 1274 and the sensor provided in electric heater 1230 correspond to sensor unit 304. The output of sensor in electric heater 1230 is applied to CPU 1320 through HA terminal 1330 and GPIO 1328.

CPU 1320 executes programs (FIGS. 19 to 25) for realizing such states of transition as shown in FIG. 16. Central control unit 101 is the same as that of the first embodiment, and operates in the similar manner. Since these are the same as those described with reference to the first embodiment, details thereof will not be repeated.

### Modification of the Fifth Embodiment

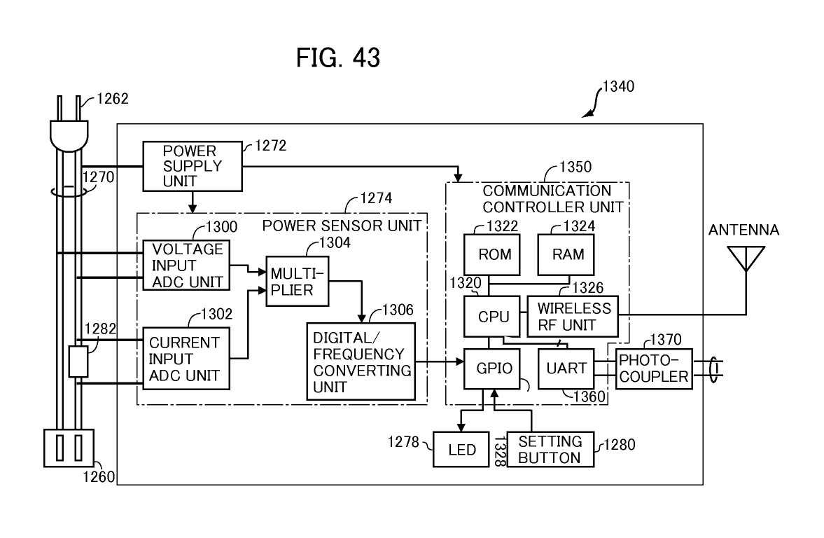

In the fifth embodiment described above, power consumption measuring device 1240 has HA terminal 1330 and when HA terminal 1330 is connected to the HA terminal of electric heater 1230, electric heater 1230 is controlled and information from electric heater 1230 is received. Similar function can be realized by using any means that is capable of bi-directional communication with an electric appliance such as electric heater 1230, other than HA terminal 1330. FIG. 43 shows a modification of the fifth embodiment.

Referring to FIG. 43, a power consumption measuring device 1340 in accordance with the modification includes: a power supply unit 1272 and a power sensor unit 1274; a communication controller unit 1350 replacing communication controller unit 1276 shown in FIG. 42; an LED 1278; a setting button 1280; and a bi-directional photo-coupler 1370 inserted between communication controller unit 1350 and a serial terminal of electric heater 1230.

Communication controller unit 1350 includes, similar to communication controller unit 1276 shown in FIG. 42, CPU 1320, ROM 1322, RAM 1324, wireless RF unit 1326, a timer, not shown, and GPIO 1328. Communication controller unit 1350 further includes, in place of HA terminal 1330 shown in FIG. 42, an UART (Universal Asynchronous Receiver-Transmitter) 1360 connected to CPU 1320, for performing conversion between parallel communication with CPU 1320 and serial communication with photo-coupler 1370. Since communication with electric heater 1230 is executed through photo-coupler 1370, power consumption measuring device 1340 is electrically insulated from electric heater 1230.

It is naturally understood that power consumption measuring device 1340 in accordance with the present modification can operate in the similar manner as power consumption measuring device 1240 in accordance with the fifth embodiment. It is noted, however, that in the modification, the electric appliance (for example, electric heater 1230) must have a terminal for serial communication.

By the power consumption measuring device in accordance with the fifth embodiment, it is possible to monitor the electric power consumed by the electric appliance through power sensor unit 1274. The power consumption measuring device can further receive the output of a sensor in the electric appliance, through bi-directional communication with the electric appliance. Based on these pieces of information, the communication controller unit transmits the cycle period of the electric appliance as the controllable component in the steady status, and the on-period necessary to maintain the steady status, to central control unit 101. As in the first embodiment, central control unit 101 is capable of collecting these pieces of information from each of the electric appliances, and forming a group of products having the same cycle period. Further, as in the first embodiment, central control unit 101 determines the on-permitting time period of electric products belonging to the same group, and transmits it to the power consumption measuring device. Based on the on-permitting time period, power consumption measuring device 1240 controls on/off of the electric appliance as the controllable component.

Therefore, by the fifth embodiment and its modification, as in the first embodiment, it becomes possible to reduce the number of electric appliances which are simultaneously on, in the group of electric appliances having the same cycle period, among the appliances included in the system. As a result, the load at the peak time of power consumption of the system can be reduced.

### Sixth Embodiment

In the embodiment above, it is possible to directly control on/off of an electric appliance as the object, or to obtain change in the status resulting from the operation of electric appliance from the sensor output. The present invention, however, it not limited to such embodiments. A power consumption measuring device not having such functions can attain not fully the same but similar effects, provided that it has the function of measuring the power consumption of electric appliance and it is capable of controlling power supply to the electric appliance. The power consumption measuring device in accordance with the sixth embodiment represents such a device.

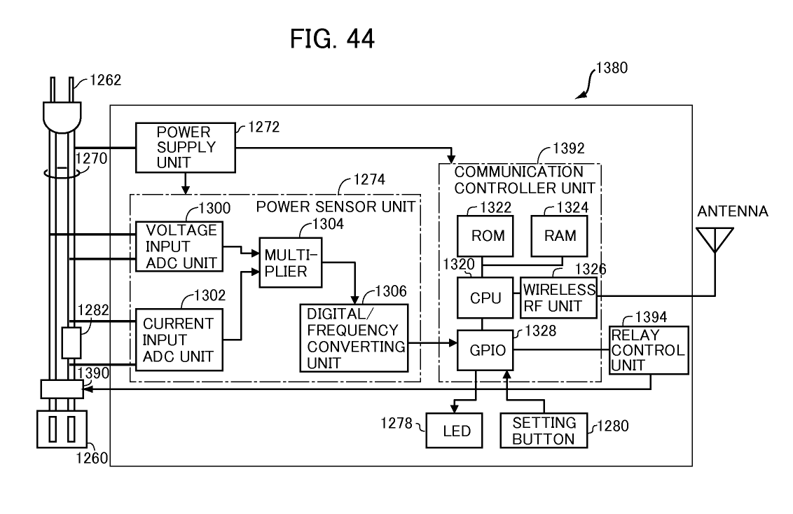

Referring to FIG. 44, a power consumption measuring device 1380 in accordance with the sixth embodiment has a configuration very similar to device 1240 shown in FIG. 42 and device 1340 shown in FIG. 43, for measuring power consumption. Specifically, power consumption measuring device 1380 includes a pair of receptacle inlets 1260 and blades 1262, lamp lines 1270, power supply unit 1272, power sensor unit 1274, a communication controller unit 1392 similar to communication controller unit 1276 shown in FIG. 42, a relay 1390 inserted between the pair of receptacle inlets 1260 and blades 1262, and a relay control unit 1394 connected to communication controller unit 1392 for operating relay 1390 in accordance with an instruction from communication controller unit 1392 and thereby turning on/off power supply to the electric appliance. Power consumption measuring device 1380 further includes LED 1278 and setting button 1280.

Communication controller unit 1392 includes, similar to communication controller unit 1276 shown in FIG. 42, CPU 1320, ROM 1322, RAM 1324, wireless RF unit 1326, a timer, not shown, and GPIO 1328. Communication controller unit 1392 is different from communication controller unit 1276 shown in FIG. 42 in that relay control unit 1394 is connected to GPIO 1328 and by controlling relay 1390 in accordance with an instruction applied from CPU 1320 through GPIO 1328, power supply to the electric appliance is turned on/off. Further, in the present embodiment, power consumption measuring device 1380 cannot use information related to the status of electric appliance as the object, except for the measurement of power consumption by power sensor unit 1274 and, in this point also, it is different from communication controller unit 1276 and the like of FIG. 42.

Because of the situation described above, different from the devices in accordance with the first to fifth embodiments, the power consumption measuring device 1380 in accordance with the sixth embodiment cannot execute very intelligent operations. Actually, in the present embodiment, regardless of the status of electric appliance as the object, on/off of power supply to the electric appliance is controlled in accordance with an instruction from central control unit 101. Therefore, the original performance of electric appliance may not be fulfilled. It is possible, however, to directly control the on time of the electric appliance and for electric appliances belonging to the same group, to shift the time point when each appliance turns on. Therefore, as in the first to fifth embodiments, the load of peak electric power of the system as a whole can be reduced.

The process executed by CPU 1320 of power consumption measuring device 1380 in accordance with the present embodiment mainly includes three processes. Namely, (1) measurement of power consumption and transmission to central control unit 101, (2) reception and storage of instruction including cycle period and on-permitting time period of electric appliance from central control unit 101 (instruction receiving process), and (3) controlling on/off of power supply to the electric appliance in accordance with the on-permitting time period received from central control unit 101 (power supply control process). Besides, there is a process for managing (synchronizing) the common time with central control unit 101 using a timer. This process, however, is the same as that executed in the first to fifth embodiments. Therefore, detailed description thereof will not be repeated here.

In the present embodiment, though power consumption measuring device 1380 measures the power consumption and transmits the measurements to central control unit 101, it does not calculate operation cycle period of the electric appliance as the controllable component. Central control unit 101 calculates the operation cycle period for each power consumption measuring device 1380 based on time-sequential data of power consumption of each electric appliance received from power consumption measuring device 1380. Calculation of operation cycle period is done by central control unit 101 executing a process having such a control structure as shown in FIG. 38. Here, it is assumed that central control unit 101 calculates the operation cycle period of each electric appliance, calculates the on-permitting time period of each electric appliance in the similar manner as in the first embodiment, and transmits an instruction including the operation cycle period and the on-permitting time period to power consumption measuring device 1380.

The method of calculating the operation cycle period of electric appliance will be described with reference to FIG. 38. Various methods may be possible to calculate the cycle period. For an appliance that operates in a relatively simple manner such as a heater, the time point when the power is turned on or off can be recognized clearly. Therefore, what is necessary is, for example, to simply measure the time interval when the power is turned on. For an appliance such as an air conditioner, the operation waveform is complicated, as shown in FIG. 36. Therefore, an elaborate calculation of cycle period becomes necessary. In the present embodiment, in order to calculate the cycle period of measurements, a number of model waveforms are prepared in advance. Each model waveform is prepared in advance by extracting a waveform of a prescribed time period (for example, 1 to 2 minutes) having a characteristic shape, from the waveform of one cycle period of some measurement (for example, of electric power), related to various types of appliances.

First, at step 1200, whether the number of data as the object of calculation of cycle period (here, measurement data of temperature) is larger than a prescribed threshold value or not is determined. If the number is equal to or smaller than the threshold value, the process ends without any operation. If the number of data is larger than the threshold value, at step 1202, correlation between data of a prescribed time period (same as the length of a model waveform) and each model waveform is calculated, and the result is stored together with the time point. The model waveforms are characteristic portions extracted from waveforms of various electric appliances. Therefore, it follows that if the measurement is obtained from the same electric appliance as the electric appliance from which the model waveform is derived, it must have the same characteristic portion of waveform as the model waveform. Therefore, in that case, if the waveform portion of interest well matches the characteristic waveform portion, correlation therebetween becomes high, while at other portions, correlation becomes low. Specifically, the correlation repeatedly becomes high in the cycle period that matches the operation cycle period of electric appliance and becomes low at other periods. Therefore, by monitoring the time interval between peak correlations, it is possible to know the operation cycle period of the electric appliance (that matches the cycle period of power consumption). On the other hand, if the model waveform is of an electric appliance different from the electric appliance as the object of measurement, the correlation is always low. Consequently, such a waveform is not used for measuring cycle period.

At step 1204, based on the principle of calculation at step 1202 described above, the time interval between peaks of correlation calculated with respect to the model waveform is calculated, and thereby the cycle period of variation waveform of power consumption by the electric appliance as the object of measurement is calculated.

The process (1) described above, that is, measurement of power consumption and transmission to central control unit 101, is a periodically executed process. The process is the same as that executed in the fifth embodiment and, therefore, detailed description thereof will not be repeated.

FIG. 45 shows a flowchart of a program realizing the instruction receiving process of (2). The program is activated by an interruption that occurs in response to CPU 1320 receiving an instruction from central control unit 101 through wireless RF unit 1326. Central control unit 101 determines the cycle period and the on-permitting time period of power consumption measuring device 1380, based on the information from power consumption measuring device 1380, using the same method as used in each electric appliance in the first embodiment. Here, the measurement as the base for the process of determining the cycle period is the measurement of power consumption of the electric appliance as the controllable component, which is transmitted from power consumption measuring device 1380 to central control unit 101 by the process (1) described above.

Referring to FIG. 45, the program includes: a step 1410 of reading the cycle period as well as the start time and end time of on-permitting time period included in the instruction from central control unit 101, from an address allocated to the instruction from central control unit 101; and a step 1412 of storing the cycle period as well as the start time and end time of on-permitting time period read at step 1410 and ending the process. The information stored in RAM 1324 is maintained as long as power is supplied to power consumption measuring device 1380. It is assumed that after the start of power supply to power consumption measuring device 1380 until the instruction is received from central control unit 101, the cycle period is initialized with a prescribed value and the start time and end time of on-permitting time period are both initialized to 0. As in the first embodiment, the start time and end time of on-permitting time period are represented by relative time with the start of cycle period being 0, respectively. Therefore, if the on-permitting time period extends over two cycle periods, it is possible that start time<end time.

The process for realizing control of power supply is as described with reference to Equations (7), (8), (E1) and (E2) above.

What is noted here is that when power supply to an electric appliance is stopped, the electric appliance stops operation, whereas the electric appliance does not always start its operation immediately when power supply to the electric appliance is started. That the power supply to an electric appliance is started simply corresponds to a process of plug-in of the electric appliance, and if a switch of the electric appliance is not yet on, if internal status of the electric appliance is not suitable for starting its operation or if its operation is unnecessary, power consumption by the electric appliance does not start. In most cases, however, when power supply to the electric appliance is started by relay 1390, the electric appliance starts its operation.

Power consumption measuring device 1380 operates in the following manner. When blades 1262 of power consumption measuring device 1380 are inserted to the receptacle, power sensor unit 1274 periodically executes the following process. Specifically, voltage input ADC unit 1300 measures the voltage across lamp lines 1270 and applies the result as a digital signal to multiplier 1304. Current input ADC unit 1302 measures the voltage at opposite ends of shunt resistance 1282 to measure the current flowing through lamp line 1270, and applies the result as a digital signal to multiplier 1304. Multiplier 1304 multiplies these two inputs with each other, and applies a digital signal representing the magnitude of electric power to digital/frequency converting unit 1306. Digital/frequency converting unit 1306 generates an output signal representing the input digital signal value (that is, quantity of power consumption) in terms of frequency, and applies it to wireless RF unit 1326. It is assumed that when power consumption measuring device 1380 operates for the first time, relay 1390 is already on.

CPU 1320 reads the output of digital/frequency converting unit 1306 through GPIO 1328. CPU 1320 calculates the electric power consumed by an electric appliance (if any) that gets power from receptacle inlet 1260, based on the frequency of the signal from digital/frequency converting unit 1306, and transmits it to central control unit 101 through wireless RF unit 1326.

The process described above is the first process executed periodically by CPU 1320.

Central control unit 101 stores this information and periodically calculates the operation cycle period and the start time and end time of on-permitting time period of each electric appliance in accordance with the method described above. Central control unit 101 transmits the result to power consumption measuring device 1380. If the contents are the same as that of the instruction sent previously to power consumption measuring device 1380, however, the transmission does not take place. In response to the signal, CPU 1320 executes the second process (instruction receiving process) described above. Specifically, CPU 1320 activates the program of instruction receiving process, and stores the cycle period, the start time and end time of on-permitting time period. If these are already stored, they are overwritten with new information. Thus, the second process ends.

The timer (not shown) provided inside communication controller unit 1392 is synchronized with the timer of central control unit 101, and using the current time obtained from the timer, it controls relay 1390 and switches power supply to the electric appliance in accordance with Equations (7), (8), (E1) and (E2) described above.

Since power consumption measuring device 1380 and central control unit 101 execute the above-described process, it follows that the electric appliance receiving power supply from receptacle inlet 1260 of power consumption measuring device 1380 can operate only in the on-permitting time period. Central control unit 101 determines the on-permitting time period such that overlapping of the on-periods of electric appliances having the same cycle period is avoided as much as possible in the cycle period, and each electric appliance can operate only in that on-permitting time period. Therefore, power consumption of the system as a whole is leveled and the peak time load can be reduced.

In the present embodiment, the bi-directional communication function required as in the fifth embodiment is unnecessary for the electric appliance connected to power consumption measuring device 1380. By inserting power consumption measuring device 1380 between the power source and each electric appliance, it becomes possible to level the power consumption of the whole system, while using conventional electric appliances as they are.

[Modification]

In the sixth embodiment described above, power supply to the electric appliance is done by controlling the relay inserted to lamp line 1270. In the sixth embodiment, however, even if the electric appliance is in operation, power supply may be shut-off regardless of the status. Therefore, the possibility of undesirable influence on the operation of some electric appliances is undeniable. It is preferable if the power supply to the electric appliances can be turned on/off without causing excessive burden on the operations of electric appliances.

Among electric appliances, some has an infrared receiving unit and allows control by an infrared remote controller, such as an air conditioner. The present modification relates to transmission of power supply on/off control signal using infrared ray to the infrared receiving unit of an electric appliance, rather than directly shutting off the power supply by a relay.

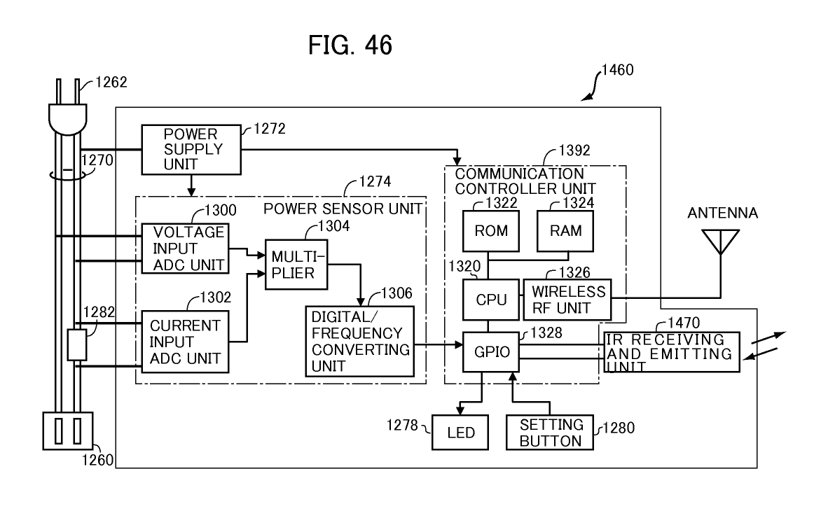

FIG. 46 is a block diagram of a power consumption measuring device 1460 in accordance with this modification. Referring to FIG. 46, power consumption measuring device 1460 differs from power consumption measuring device 1380 shown in FIG. 43 in that it does not include relay 1390 and relay control unit 1394 shown in FIG. 43 and in place of these, it includes an IR receiving and emitting unit 1470 receiving an instruction from CPU 1320 through wireless RF unit 1326 and outputting an infrared signal for controlling an electric appliance. It is assumed that IR receiving and emitting unit 1470 is a general purpose unit and, therefore, it must learn what type of infrared signal is to be emitted for controlling the electric appliance. IR receiving and emitting unit 1470 has a light receiving function for this purpose. An infrared signal from an IR remote controller of the electric appliance as the controllable component is received by IR receiving and emitting unit 1470. CPU 1320 can learn what type of infrared signal is to be emitted for controlling the electric appliance based on the received signal. Except for this point, power consumption measuring device 1460 is the same as power consumption measuring device 1380.

In the present modification, in place of directly turning on/off power supply to the electric appliance, the electric appliance is turned on/off as a normal control using the infrared signal. While power supply to the electric appliance is on, the electric appliance executes the normal operation in accordance with the environment. It stops such an operation when power supply is turned off. Therefore, the time period in which the electric appliance is on is limited within the on-permitting time period designated by central control unit 101. The on-permitting time periods are selected by central control unit 101 in distributed manner among the electric appliances having the same cycle period in order to level the power consumption and, therefore, in the system of this modification also, the peak load of power consumption by the system as a whole can be reduced.

IR receiving and emitting unit 1470 must be allocated to such a position where an infrared command can be transmitted correctly to the IR receiving unit of the appliance as the controllable component. Therefore, the overall shape, especially a mechanism holding IR receiving and emitting unit 1470 may possibly be much different from those of the first to sixth embodiments. If possible, it is preferred to connect IR receiving and emitting unit 1470 and wireless RF unit 1326 by, for example, a relatively thin cable, so that IR receiving and emitting unit 1470 can be allocated at any desirable position.

Further, as the mechanism for controlling the electric appliance, four mechanisms have been described in the fifth and sixth embodiments. The present invention, however, is not limited to such embodiments. The present invention may be applicable to any other control mechanism that can control the electric appliance. For example, wireless RF remote controller may be used.

In the foregoing, configurations of some embodiments of the present invention have been described. Though a situation in which a battery is provided in a house is not considered in the embodiments above, it is clearly understood that determination of operation timing becomes easier when a battery is combined.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention enables control of power consumption while realizing appropriately controlled operations of a plurality of electric appliances. Therefore, the present invention is applicable to power consumption control at places, including houses, where a plurality of electric appliances are used.

### REFERENCE SIGNS LIST

101, 1160 central control unit
102 distribution panel
103 router
104 IP network
110 air conditioner
111 electric heater
112 refrigerator
113 washer-dryer
120 communication OF
301 electric appliance control unit
304 sensor unit
305 display unit
306, 403 timer
307, 404 time synchronizing unit
308 status management unit
309 controller
310 controllable component
401 central control unit controller
405 table storage unit
1162 collective housing
1240, 1340, 1380, 1460 power consumption measuring device
1274 power sensor unit
1276, 1350, 1380, 1392 communication controller unit

1. An electric appliance, comprising:
a controller for controlling a controllable component consuming electric power to operate and for controlling the electric power;
a sensor obtaining information related to external environment prone to change reflecting a result of operation by said controllable component;
a control device controlling said controller such that the electric power applied to said controllable component is adjusted to have a numerical value obtained by said sensor kept within a prescribed target range; and
a timer synchronized with a prescribed reference time; wherein
said control device is capable of controlling said controller such that said controllable component attains to a steady status;
said electric appliance further comprising:
a transmitting device for calculating, in response to the control by said control device entering the steady status, a cycle period in said steady status and a time period necessary for applying electric power to said controllable component to maintain said steady status and applying results of calculation to a prescribed central control unit through a communication interface; and
a receiving device for receiving an instruction generated by said central control unit, including cycle period information and time period information in which power supply to said controllable component is permitted within the cycle period specified by said cycle period information; wherein
said control device includes a device for controlling said controller such that electric power is supplied to said controllable component from a prescribed time point within the time period specified by said time period information and the numerical value obtained by said sensor is kept within the prescribed target range, based on the instruction received from said receiving device and on an output from said timer.

2. The electric appliance according to claim 1, wherein
said transmitting device includes
a status management device for managing status of control by said control device based on the output of said sensor,
a cycle period measuring device for measuring, in response to the status managed by said status management device entering the steady status, cycle period of control by said control device in said steady status,
a cycle period adjustment device for adjusting cycle period of control by said control device such that the cycle period measured by said cycle period measuring device comes closer to a target cycle period, and
a device for calculating, in response to the status managed by said status management device entering the steady status and to a difference between the cycle period measured by said cycle period measuring device and the target cycle period becoming smaller than a prescribed threshold value, the target cycle period and a time period necessary for supplying electric power to said controllable component to maintain said steady status in the cycle period, and applying results of calculation to said central control unit through said communication interface.

3. The electric appliance according to claim 1, wherein said control device controls electric power applied to said controllable component to any of a plurality of values so as to maintain the numerical value obtained by said sensor within the prescribed target range.

4. The electric appliance according to claim 3 wherein said plurality of values include two values of 0 and a prescribed positive value.

5. A central control unit, comprising:
a receiving device receiving a notice related to a cycle period of power consumption and a time period requiring power supply, from each of a plurality of electric appliances of which power consumption changes periodically;
a classifying device classifying, based on the notices received by said receiving device from said plurality of electric appliances, a group of electric appliances having the same cycle period;
an allocating device allocating, for each of the group of electric appliances classified by said classifying device, a time period permitting power supply to each electric appliance in said cycle period, to have total power consumption by the electric appliances to which power supply is permitted in said cycle period made as flat as possible; and
a notifying device for notifying each of the electric appliances included in each group of electric appliances classified by said classifying device, of the cycle period of power supply to said group and the time period permitting power supply to the electronic appliance within the cycle period.

6. The central control unit according to claim 5, wherein said allocating device allocates a prescribed interval between the time period allocated to a first electric appliance and the time period allocated to a second electric appliance.

7. The central control unit according to claim 5, wherein
said allocating device includes
a storage device for storing pieces of appliance information including power consumption of electric appliances of said group, identification numbers of the electric appliances, and time periods of power supply required by the electric appliances,
a selecting device for selecting, from among said pieces of appliance information stored in said storage device, apiece corresponding to the appliance of which period of permitting power supply is not yet allocated in said cycle period,
a power difference calculating device for calculating, for the piece of appliance information selected by said selecting device, after provisionally allocating power supply permitting time period permitting power supply to every possible positions in said cycle period, difference between maximum and minimum values of total power consumption of all electric appliances of which power supply permitting time periods are allocated in said cycle period at that time,
a device for non-provisionally allocating the power supply permitting time period of the electric appliance selected by said selecting device at a position where the value calculated by said power difference calculating device is the smallest, and
a device causing said selecting device, said power difference calculating device and the device for non-provisionally allocating to operate repeatedly from a status in which said power supply permitting time period is not yet allocated in said cycle period until a status in which the power supply permitting time periods of all electric appliances belonging to said group are allocated is attained.

8. A system for managing electric appliances, comprising:
a network;
one or more electric appliances each connected to said network; and
a central control unit connected to said network for managing said one or more electric appliances through said network such that said one or more electric appliances operate in a coordinated behavior; wherein
each of said one or more electric appliances includes
a controller controlling a controllable component consuming electric power to operate and controlling the electric power,
a sensor obtaining information related to external environment prone to change reflecting a result of operation by said controllable component,
a control device controlling said controller such that the electric power applied to said controllable component is adjusted to have a numerical value obtained by said sensor kept within a prescribed target range, and
a timer synchronized with a prescribed reference time, wherein
said control device is capable of controlling said controller such that said controllable component attains to a steady status,
each of said one or more electric appliances further includes
a transmitting device for calculating, in response to the control by said control device entering the steady status, a cycle period in said steady status and a time period necessary for applying electric power to said controllable component to maintain said steady status and applying results of calculation to a prescribed central control unit through a communication interface, and
a receiving device for receiving an instruction generated by said central control unit, including cycle period information and time period infatuation in which power supply to said controllable component is permitted within the cycle period specified by said cycle period information, wherein
said control device includes a device for controlling said controller such that electric power is supplied to said controllable component from a prescribed time point within the time period specified by said time period information and the numerical value obtained by said sensor is kept within the prescribed target range, based on the instruction received from said receiving device and on an output from said timer; and
said central control unit includes
a receiving device receiving a notice related to a cycle period of power consumption and a time period requiring power supply, from said one or more electric appliances,
a classifying device classifying, based on the notices received by said receiving device from said plurality of electric appliances, a group of electric appliances having the same cycle period,
an allocating device allocating, for each of the group of electric appliances classified by said classifying device, a time period permitting power supply to each electric appliance in said cycle period, to have total power consumption by the electric appliances to which power supply is permitted in said cycle period made as flat as possible, and
a notifying device for notifying each of the electric appliances included in each group of electric appliances classified by said classifying device, of the cycle period of power supply to said group and the time period permitting power supply to the electronic appliance within the cycle period.

9. A computer program, causing, when executed by a computer connected to one or more electric appliance, said computer to function as
a receiving device receiving a notice related to a cycle period of power consumption and a time period requiring power supply, from each of a plurality of electric appliances of which power consumption changes periodically;
a classifying device classifying, based on the notices received by said receiving device from said plurality of electric appliances, a group of electric appliances having the same cycle period;
an allocating device allocating, for each of the group of electric appliances classified by said classifying device, a time period permitting power supply to each electric appliance in said cycle period, to have total power consumption by the electric appliances to which power supply is permitted in said cycle period made as flat as possible; and
a notifying device for notifying each of the electric appliances included in each group of electric appliances classified by said classifying device of the cycle period of power supply to said group and the time period in which power supply to the electronic appliance is allocated within the cycle period.

10. A storage medium storing the computer program according to claim 9.

11. A method of managing a central control unit for electric appliances, said central control unit including
a receiving device receiving a notice related to a cycle period of power consumption and a time period requiring power supply, from each of a plurality of electric appliances of which power consumption changes periodically,
a classifying device classifying, based on the notices received by said receiving device from said plurality of electric appliances, a group of electric appliances having the same cycle period,
an allocating device allocating, for each of the group of electric appliances classified by said classifying device, a time period permitting power supply to each electric appliance in said cycle period, to have total power consumption by the electric appliances to which power supply is permitted in said cycle period made as flat as possible, and
a notifying device for notifying each of the electric appliances included in each group of electric appliances classified by said classifying device of the cycle period of power supply to said group and the time period in which power supply to the electronic appliance is allocated within the cycle period;
said method comprising:
the receiving step of said receiving device receiving a notice related to a cycle period of power consumption and a time period requiring power supply, from each of a plurality of electric appliances of which power consumption changes periodically;
the classifying step of said classifying device classifying, based on the notices received at said receiving step from said plurality of electric appliances, a group of electric appliances having the same cycle period;
the allocating step of said allocating device allocating, for each of the group of electric appliances classified at said classifying step, a time period permitting power supply to each electric appliance in said cycle period, to have total power consumption by the electric appliances to which power supply is permitted in said cycle period made as flat as possible; and
the notifying step of said notifying device notifying each of the electric appliances included in each group of electric appliances classified at said classifying step of the cycle period of power supply to said group and the time period in which power supply to the electronic appliance is allocated within the cycle period.

12. An electric appliance control device used connected to an electric appliance having a sensor for detecting information related to environmental condition prone to change reflecting a result of operation by itself and having a function of operating based on an output of said sensor to maintain said sensor output within a prescribed range, for controlling power consumption of said electric appliance, said device comprising:
a sensor output receiving device receiving a sensor output from said electric appliance;
a timer synchronized with a prescribed reference time;
a transmitting device detecting, based on an output from said sensor output receiving device, steady status of operation of said electric appliance being attained, calculating a cycle period in said steady status and a time period necessary for said electric appliance to receive power supply to maintain said steady status and transmitting calculated results to a prescribed central control unit; and
a receiving device receiving an instruction from said central control unit; wherein
said instruction includes cycle period information for specifying a cycle period of operation of said electric appliance and on-permitting time period information permitting turning on of said controllable component in the cycle period specified by said cycle period information;
said control device further comprising:
a power regulating device regulating power consumption of said electric appliance such that said electric appliance consumes power in the time period specified by said on-permitting time period information, based on the instruction received from said receiving device and on an output of said timer.

13. The electric appliance control device according to claim 12, further comprising
a power sensor unit provided in relation to a power line supplying electric power to said electric appliance to enable detection of electric power supplied to said electric appliance through said power line; and
a power consumption transmitting unit for periodically transmitting an output of said power sensor unit to said central control unit.

14. The electric appliance control device according to claim 12, wherein
said electric appliance is capable of changing its status in response to an external instruction in accordance with a prescribed standard; and
said power regulating device includes an instruction transmitting unit transmitting an instruction to said electric appliance in accordance with said prescribed standard such that in synchronization with time keeping by said timer, for each cycle period, said electric appliance turns on at the head of said on-permitting time period and said electric appliance attains to an off status at the tail of said on-permitting time period.

15. The electric appliance control device according to claim 12, wherein said power regulating device includes a switch provided in a power supply line to said electric appliance, turning on at the head of said on-permitting time period and turning off at the tail of said on-permitting time period, in synchronization with time keeping by said timer, for each cycle period.

16. A power control device, used connected to an electric appliance having a function of detecting environmental condition prone to change reflecting a result of operation by itself and operating to have said environmental condition satisfy prescribed conditions, for controlling power consumption by said electric appliance, comprising:
a power sensor provided in relation to a power line supplying electric power to said electric appliance, enabling detection of electric power supplied through said power line to said electric appliance;
a timer synchronized with a prescribed reference time; and
a communication apparatus periodically transmitting an output of said power sensor to a prescribed central control unit and receiving an instruction from said central control unit; wherein
said instruction includes cycle period information specifying a cycle period of operation of said electric appliance and on-permitting time period information permitting turning on of said controllable component in the cycle period specified by said cycle period information;
said power control device further comprising a power supply switch for supplying electric power to said electric appliance in a time period specified by said on-permitting time period information and stopping power supply to said electric appliance in other time periods, for each cycle period, based on the instruction received from said central control unit and an output from said timer.

17. The power control device according to claim 16, further comprising:
a plug portion to be inserted to a receptacle for power supply;
a receptacle portion for receiving a plug of said electric appliance; and
a pair of lamp lines connecting said plug portion and said receptacle portion; wherein
said power supply switch includes
a relay inserted to either one of said pair of lamp lines, and
a relay control device controlling said relay such that said relay is on in a time period specified by said on-permitting time period information and said relay is off in other time periods, for each cycle period, based on the instruction received from said central control unit and on an output from said timer.
